(19) United States
(12) Patent Application Publication
(10) Pub. No.: US 2009/0141325 A1
(43) Pub. Date: Jun. 4, 2009

(54) Hologram Device and Recording Method

(76) Inventors: Makoto Sato, Saitama (JP); Masakazu Ogasawara, Saitama (JP)

Correspondence Address: DRINKER BIDDLE & REATH (DC), 1500 K STREET, N.W., SUITE 1100, WASHINGTON, DC, 20005-1209, US

(21) Appl. No.: 11/885,780

(22) PCT Filed: Mar. 6, 2006
(86) PCT No.: PCT/JP2006/004816

§ 371 Date: Nov. 26, 2007

(30) Foreign Application Priority Data
Mar. 7, 2005 (JP) 2005-061898

(51) Int. Cl. G03H 1/10; G03H 1/04

(52) U.S. Cl. 359/21; 359/1

(57) ABSTRACT

A hologram apparatus capable of recording and reproduction of a recording medium with stability. The hologram apparatus includes: a suspension unit for holding a recording medium in a freely mountable fashion, the recording medium storing an optical interference pattern inside as a diffraction grating; a reference light optical system for emitting reference light toward the recording medium; and a signal light optical system for emitting signal light toward the recording medium, being arranged on a side opposite from the reference light optical system coaxially across the recording medium, the diffraction grating being formed by opposite irradiation of the recording medium with the signal light and the reference light. The hologram apparatus has: an objective lens for condensing the reference light with a first numerical aperture; and a spatial light modulation device for generating the signal light from the reference light past the recording medium and making it pass through the recording medium with a second numerical aperture different from the first numerical aperture, the signal light being modulated according to recorded information.

### TECHNICAL FIELD

The present invention relates to a hologram apparatus and a recording method for irradiating a recording medium for information to be optically recorded into or reproduced from, such as an optical disk and an optical card, with light in opposite directions.

### BACKGROUND ART

Conventionally, there have been known technologies for recording a hologram in a recording medium volumetrically by irradiating a recording layer with light beams from one side so that the light beams converge to a minimum diameter at almost the same position on a reflecting layer. See Japanese Patent Kokai No. 2004-171611 (patent document 1). According to these technologies, as shown in FIG. 1, reference light and signal light are introduced by an objective lens OB so as to overlap each other coaxially during recording. The reference light and the signal light focused by the objective lens OB are in an interference state on the optical axis all the time. As shown in FIG. 1, when the recording medium is placed so that the reflecting layer falls on the focal point of the signal light, the reference light and the signal light then pass through and back the recording medium for hologram recording. For reproduction, the reference light is also passed through and back the recording medium, so that the reflected reference light returns to the objective lens OB along with reproduction light.

Specifically, as shown in FIG. 2, holograms to be recorded are the following four types: hologram recording A (with reflected reference light and reflected signal light), hologram recording B (with incident reference light and reflected signal light), hologram recording C (with reflected reference light and incident signal light), and hologram recording D (with incident reference light and incident signal light). Holograms to be reproduced are also the following four types: hologram recording A (read with reflected reference light), hologram recording B (read with incident reference light), hologram recording C (read with reflected reference light), and hologram recording D (read with incident reference light). Since all the light beams (the incident beam and reflected beam of reference light, and the incident beam and reflected beam of information light) interfere in the recording layer, a plurality of holograms are inevitably recorded and reproduced. This has been described, for example, in paragraphs (0096) and (0097) of patent document 1.

As above, according to the conventional method of patent document 1, when recording a hologram on a recording medium of reflection type, four holograms are inevitably recorded because of interference between the four light beams, or incident and reflected reference light and signal light, with a waste of the capabilities of the recording medium. During information reproduction, it is therefore necessary to separate reproduction light from reproduced holograms since the reference light is reflected by the signal light from the recording medium. This causes a drop in the performance of reading the reproduction light.

Meanwhile, among conventional technologies for solving this problem, there has been known a method in which an objective lens for emitting reference light is opposed to another objective lens across a recording medium of transmission type as shown in FIG. 3. The recording medium is irradiated with the reference light and with information light passed through a spatial light modulator from respective opposite sides coaxially so that the light beams converge to a minimum diameter at the same position, thereby recording a hologram in the recording medium volumetrically. See Japanese Patent Kokai No. 2002-123948 (patent document 2).

According to this technology, during recording, the information light is generated by spatially modulating light in accordance with information to be recorded, using the spatial light modulator. The information light is condensed by the opposed objective lens and projected to the recording medium. The reference signal for recording is condensed by the objective lens and projected to the recording medium. The information light and the reference light for recording interfere with each other to form an interference pattern in the information recording layer, and this interference pattern is recorded in the information recording layer volumetrically. For reproduction, the recording medium is irradiated with the reference light alone from the objective lens.

### DISCLOSURE OF THE INVENTION

According to the technology described in patent document 2, it is difficult to separate the reference light and reproduction light during reproduction. The reason is that the pair of objective lenses are arranged across the recording medium, and the reference light and the reproduction light conversing into the same focal point are collected to the recording medium from the respective objective lenses overlappingly.

Moreover, in this conventional method, the reference light and the reproduction light of spherical waves converge to the single point. It follows that the angle of intersection between the two light beams is 180°, which increases the angular selectivity and is thus unsuited to high density recording by shift multiplexing. It also requires accurate positioning between the objective lenses and the recording medium. The two objective lenses must also be maintained at a precise relative distance, which complicates the objective lens driving systems and servo systems.

It is thus an object of the present invention to provide a hologram apparatus and a recording method which allow stable recording or reproduction of a recording medium.

A hologram apparatus according to one aspect of the present invention includes: a suspension unit for holding a recording medium in a freely mountable fashion, the recording medium storing an optical interference pattern inside as a diffraction grating; a reference light optical system for emitting reference light toward the recording medium; and a signal light optical system for emitting signal light toward the recording medium, being arranged on a side opposite from the reference light optical system coaxially across the recording medium, the diffraction grating being formed by opposed irradiation of the recording medium with the signal light and the reference light. The hologram apparatus has: an objective lens for condensing the reference light with a first numerical aperture; and a spatial light modulation device for generating signal light from the reference light past the recording medium and making it pass through the recording medium with a second numerical aperture different from the first numerical aperture, the signal light being modulated according to recorded information.

The hologram recording method mentioned above is one intended for a hologram apparatus including: a reference light optical system for emitting reference light to a recording medium by using an objective lens, the recording medium storing an optical interference pattern inside as a diffraction grating; and a signal light optical system for emitting signal light toward the recording medium, being arranged on a side opposite from the reference light optical system coaxially across the recording medium, the diffraction grating being formed by opposed irradiation of the recording medium with the signal light and the reference light. The method comprises the steps of: condensing the reference light to the recording medium for transmission with a first numerical aperture, by using the objective lens in the reference light optical system; passing the transmitted reference light through a spatial light modulator without modulation in the signal light optical system; and reflecting the passed reference light by a reflecting part so that it is transmitted through the spatial light modulator, thereby generating the signal light modulated according to recorded information and passing it through the recording medium with a second numerical aperture different from the first numerical aperture.

### BRIEF DESCRIPTION OF THE DRAWINGS

FIG. 1 is a schematic partial sectional view showing an objective lens and a hologram recording medium for explaining conventional hologram recording;

FIG. 2 is a schematic partial sectional view showing a hologram recording medium for explaining conventional hologram recording;

FIG. 3 is a schematic partial sectional view showing an objective lens, a hologram recording medium, and a spatial light modulation device for explaining conventional hologram recording;

FIG. 4 is a schematic partial sectional view showing an objective lens, a hologram recording medium, and a spatial light modulation device for explaining hologram recording in a hologram apparatus according to an embodiment of the present invention;

FIG. 5 is a schematic partial sectional view showing the objective lens, the hologram recording medium, and the spatial light modulator for explaining the hologram recording according to the present invention;

FIG. 6 is a schematic perspective view showing the spatial light modulator of the hologram apparatus according to the embodiment of the present invention;

FIG. 7 is a schematic perspective view showing a spatial light modulator of a hologram apparatus according to another embodiment of the present invention;

FIG. 8 is a schematic partial sectional view showing an objective lens, a hologram recording medium, and a spatial light modulation device for explaining hologram recording in a hologram apparatus according to another embodiment of the present invention;

FIG. 9 is a schematic partial sectional view showing an objective lens, a hologram recording medium, and a spatial light modulation device for explaining hologram recording in a hologram apparatus according to another embodiment of the present invention;

FIG. 10 is a schematic partial sectional view showing an objective lens, a hologram recording medium, and a spatial light modulation device for explaining hologram recording in a hologram apparatus according to another embodiment of the present invention;

FIG. 11 is a schematic partial sectional view showing an objective lens, a hologram recording medium, and a spatial light modulation device for explaining hologram reproduction in the hologram apparatus according to the embodiment of the present invention;

FIG. 12 is a schematic partial sectional view showing an objective lens, a hologram recording medium, and a spatial light modulation device for explaining hologram reproduction in a hologram apparatus according to another embodiment of the present invention;

FIG. 13 is a schematic partial sectional view showing an objective lens, a hologram recording medium, and a spatial light modulation for explaining hologram reproduction in a hologram apparatus according to another embodiment of the present invention;

FIG. 14 is a partly-broken schematic perspective view showing the spatial light modulator of the hologram apparatus according to the embodiment of the present invention;

FIG. 15A is a schematic partial sectional view showing an objective lens, a hologram recording medium, and a spatial light modulation device for explaining hologram recording in a hologram apparatus according to another embodiment of the present invention;

FIG. 15B is a schematic partial sectional view showing an objective lens, a hologram recording medium, and a spatial light modulation device for explaining hologram recording in a hologram apparatus according to another embodiment of the present invention;

FIG. 16A is a schematic partial sectional view showing an objective lens, a hologram recording medium, and a spatial light modulation device for explaining hologram recording in a hologram apparatus according to another embodiment of the present invention;

FIG. 16B is a schematic partial sectional view showing an objective lens, a hologram recording medium, and a spatial light modulation device for explaining hologram recording in a hologram apparatus according to another embodiment of the present invention;

FIG. 17 is a schematic configuration diagram for explaining a reference light optical system and a signal light optical system, or essential parts of a hologram apparatus according to another embodiment of the present invention;

FIG. 18 is a schematic configuration diagram showing a hologram apparatus according to another embodiment of the present invention;

FIG. 19 is a schematic perspective view for explaining a reference light optical system and a signal light optical system, or essential parts of a hologram apparatus according to another embodiment of the present invention;

FIG. 20 is a schematic partial sectional view showing an objective lens, a hologram recording medium, and a spatial light modulation device for explaining hologram recording in a hologram apparatus according to another embodiment of the present invention;

FIG. 21 is a schematic partial sectional view showing an objective lens, a hologram recording medium, and a spatial light modulation device for explaining hologram recording in a hologram apparatus according to another embodiment of the present invention;

FIG. 22 is a schematic configuration diagram for explaining a reference light optical system and a signal light optical system, or essential parts of a hologram apparatus according to another embodiment of the present invention;

FIG. 23 is a block diagram showing the schematic configuration of a hologram apparatus for recording or reproducing information on/from a recording medium according to the embodiment of the present invention;

FIG. 24 is a schematic configuration diagram showing essential parts of a pickup in the hologram apparatus for recording or reproducing information on/from a recording medium according to the embodiment of the present invention;

FIG. 25 is a partly-broken schematic perspective view showing an objective lens assembly in the pickup of the hologram apparatus according to the embodiment of the present invention;

FIG. 26 is a schematic perspective view showing the outline of a triaxial actuator intended for the spatial light modulation device in the pickup of the hologram apparatus according to the embodiment of the present invention;

FIG. 27 is a schematic partial sectional view showing an objective lens, a hologram recording medium, and a spatial light modulation device for explaining hologram recording in a hologram apparatus according to another embodiment of the present invention;

FIG. 28 is a schematic partial sectional view showing an objective lens, a hologram recording medium, and a spatial light modulation device for explaining hologram recording in a hologram apparatus according to another embodiment of the present invention;

FIG. 29 is a partial sectional view showing a disk-like hologram recording medium in the hologram apparatus according to the embodiment of the present invention;

FIG. 30 is a plan view showing the photoreceptor part of an objective servo photodetector in the pickup of the hologram apparatus for recording or reproducing information on/from a recording medium according to the embodiment of the present invention;

FIG. 31 is a set of plan views for explaining the photoreceptor part of a reflection servo photodetector in the pickup of the hologram apparatus for recording or reproducing information on/from a recording medium according to the embodiment of the present invention;

FIG. 32 is a schematic perspective view showing the outline of the pickup of a hologram apparatus according to another embodiment of the present invention;

FIG. 33 is a schematic partial sectional view showing an objective lens, a hologram recording medium, and a spatial light modulation device for explaining the spatial light modulator of a hologram apparatus according to another embodiment of the present invention, accompanied with a plan view of the spatial light modulator;

FIG. 34 is a schematic partial sectional view showing an objective lens, a hologram recording medium, and a spatial light modulation device for explaining the spatial light modulator of a hologram apparatus according to another embodiment of the present invention, accompanied with a plan view of the spatial light modulator;

FIG. 35 is a schematic partial sectional view showing an objective lens, a hologram recording medium, and a spatial light modulation device for explaining the spatial light modulator of a hologram apparatus according to another embodiment of the present invention, accompanied with a plan view of the spatial light modulator; and

FIG. 36 is a schematic partial sectional view showing an objective lens, a hologram recording medium, and a spatial light modulation device for explaining the spatial light modulator of a hologram apparatus according to another embodiment of the present invention, accompanied with a plan view of the spatial light modulator.

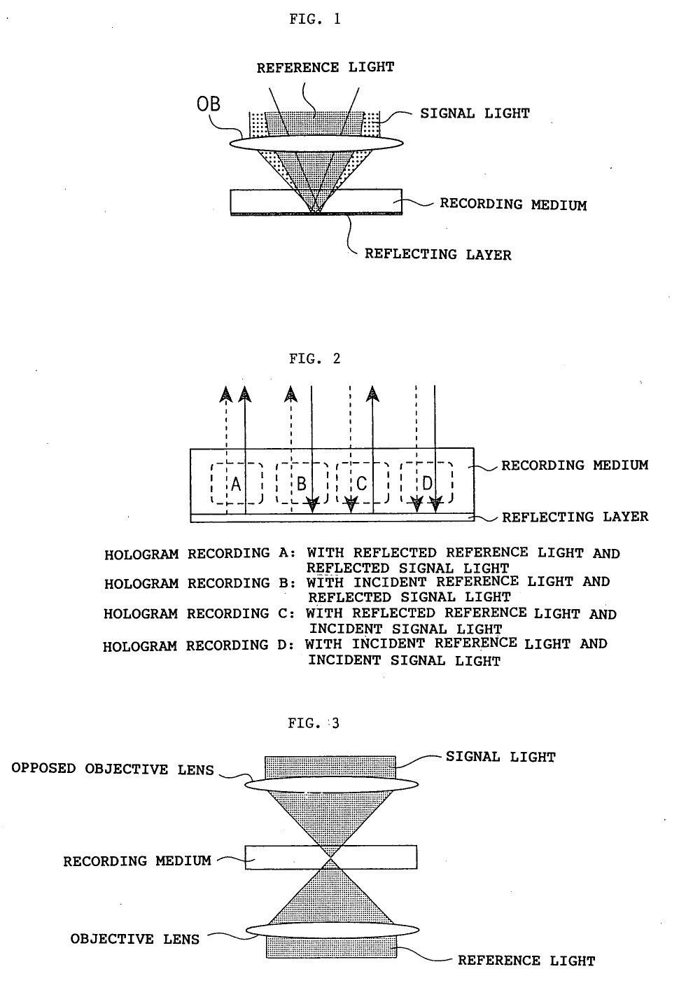

### MODE FOR CARRYING OUT THE INVENTION

Hereinafter, embodiments of the present invention will be described with reference to the drawings.

FIG. 4 schematically shows essential parts of optical systems in a hologram apparatus according to an embodiment.

The apparatus has a reference light optical system rOS and a signal light optical system sOS, which are arranged apart on the same optical axis at opposite positions with a hologram recording medium (recording medium) 2 therebetween.

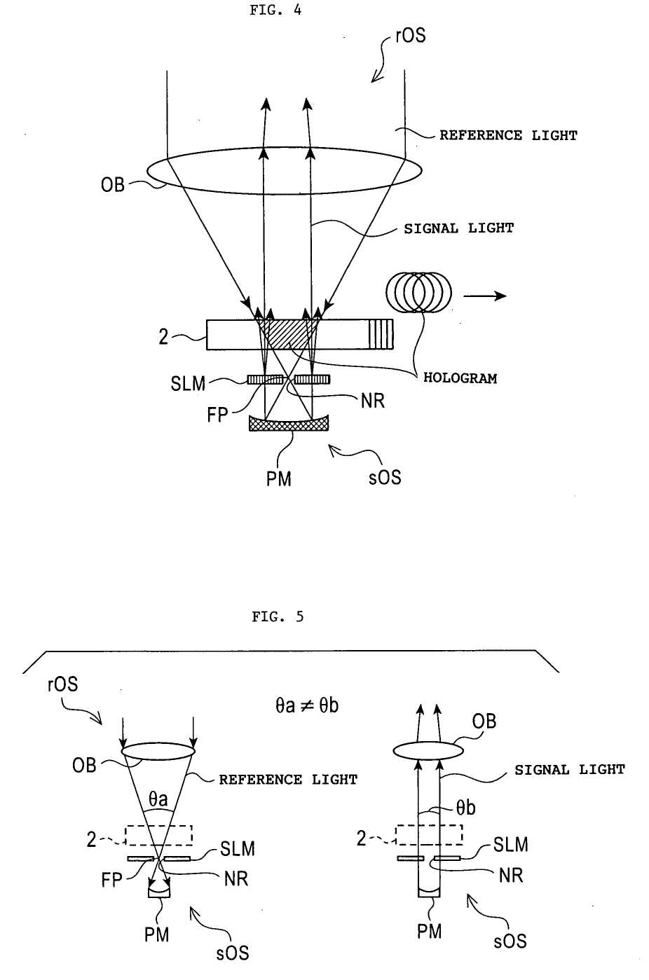

The reference light optical system rOS generates reference light and receives reproduction light, and includes an objective lens OB for focusing the reference light. As shown in FIG. 5, the objective lens OB focuses the reference light from within its effective diameter onto its focal point FP with a first numerical aperture (sin θa).

The signal light optical system sOS includes a spatial light modulator SLM of transmission type. The spatial light modulator SLM is located on the focal point FP of the objective lens OB, for example. The spatial light modulator SLM has a light transmission part NR in the center, including its optical axis, and is arranged so that the reference light converging to the light transmission part NR passes through without modulation.

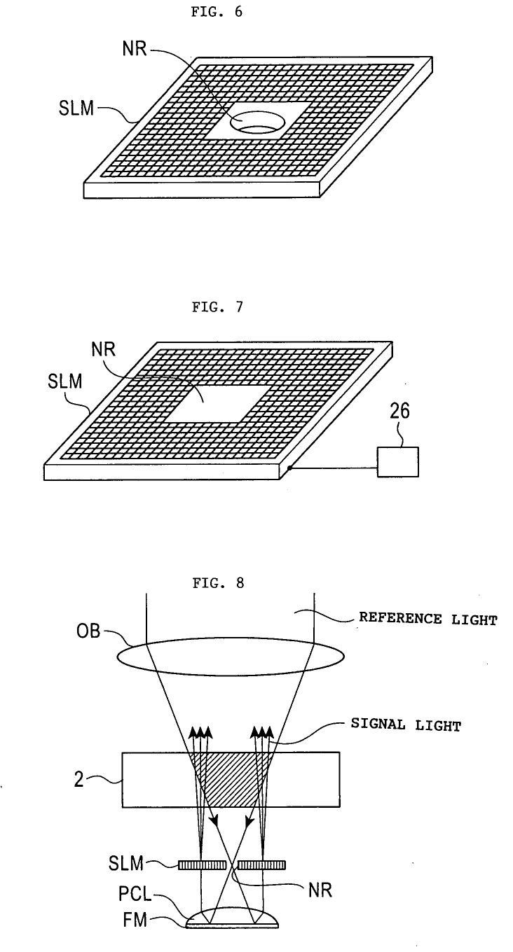

As shown in FIG. 6, the spatial light modulator SLM is made of a matrix liquid crystal device of transmission type. The light transmission part NR, surrounded by a spatial light modulation region B, is physically made of a through opening or a transparent material filled therein. As shown in FIG. 7, the entire spatial light modulator SLM may be made of a matrix liquid crystal device of transmission type so that a control circuit 26 connected thereto displays a recording pattern on the spatial light modulation region B, and a non-modulation light transmission area for the light transmission part NR inside. That is, the light transmission part NR may be rendered as a transmitting state of the spatial light modulator SLM during hologram recording.

As shown in FIGS. 4 and 5, aside from the spatial light modulator SLM, the signal light optical system sOS also includes a concave mirror such as a parabolic mirror PM on the side opposite from the incidence side. The mirror is intended to generate a parallel beam of plane wave from the reference light of spherical wave that is transmitted through the recording medium 2 and the light transmission part NR of the spatial light modulator SLM with dispersion. The parabolic mirror PM is coaxially arranged so that its focus coincides with the focal point FP of the objective lens OB.

The signal light optical system sOS is arranged so that the parallel beam from the parabolic mirror PM passes through the spatial light modulator SLM and returns to the objective lens OB of the reference light optical system rOS.

Consequently, in the optical systems, as shown in FIG. 5, the parabolic mirror PM and the spatial light modulator SLM generate signal light by spatially modulating the parallel beam according to recording information, and make it pass through the recording medium 2 with a second numerical aperture different from the first numerical aperture of the objective lens OB (sin θb≠sin θa) (θb=0 for parallel light) in the direction opposite from the reference light.

The spatial light modulator SLM having the light transmission part NR including its optical axis has the function of separating the reference light which passes through the light transmission part NR and the signal light which is generated in the peripheral ring-shaped area of the spatial light modulator SLM around the light transmission part NR. Then, the parabolic mirror PM has the function of determining the effective diameter and the numerical aperture of the signal light beam to be emitted. That is, the reflecting part such as the parabolic mirror PM gives the emission light beam a different sectional area and a wavefront of different state from among parallel, converging, and diverging wavefronts than those of the ambient reference light. In this way, because of the reflecting part lying behind the spatial light modulator SLM, the signal light passes through the recording medium 2 toward the objective lens OB with the second numerical aperture which is different, e.g., smaller than the first numerical aperture.

As shown in FIGS. 4 and 5, during recording, the recording medium 2 is irradiated with the reference light that is focused by the objective lens OB. The reference light past the recording medium 2 comes into focus and is passed through the spatial light modulator SLM without modulation, and in the process of becoming diffusing light again, it is reflected into parallel light by the reflecting part such as the parabolic mirror PM. The resulting parallel reflection light (reference light) is transmitted through the spatial light modulator SLM on the way to the recording medium 2, being modulated into signal light according to the recording information. The recording medium 2 is irradiated with the signal light of plane wave, which interferes with the incoming reference light of spherical wave inside the recording medium 2 for hologram recording. The spatial light modulator SLM does not affect the incoming reference light because of the light transmission part NR near the focus of the incoming reference light.

For reproduction, the reflecting part behind the recording medium 2 is unnecessary. Non-reflection means for stopping the function of the reflecting part so as not to reflect reference light is thus provided so that it is possible to irradiate the surface side of the recording medium 2 with reference light and obtain reproduction light from the same side without being hindered by the reference light.

In hologram recording or recording/reproducing apparatuses, the signal light optical system sOS is provided with such non-reflection means inside while the reference light optical system rOS includes a photodetector for detecting reproduction light occurring from the recording medium 2 and optical means for introducing the reproduction light from the objective lens OB to the photodetector. In read-only hologram apparatuses, the signal light optical system sOS is unnecessary.

In the embodiment, the reference light consists of spherical waves, and the signal light consists of plane waves. This makes it possible to secure some crossing angles between the beams of the reference light and the signal light, being suited to shift multiplex recording. As in FIG. 4, the recording medium 2 can be shifted in directions perpendicular to the optical axis of the objective lens OB for multiplex recording.

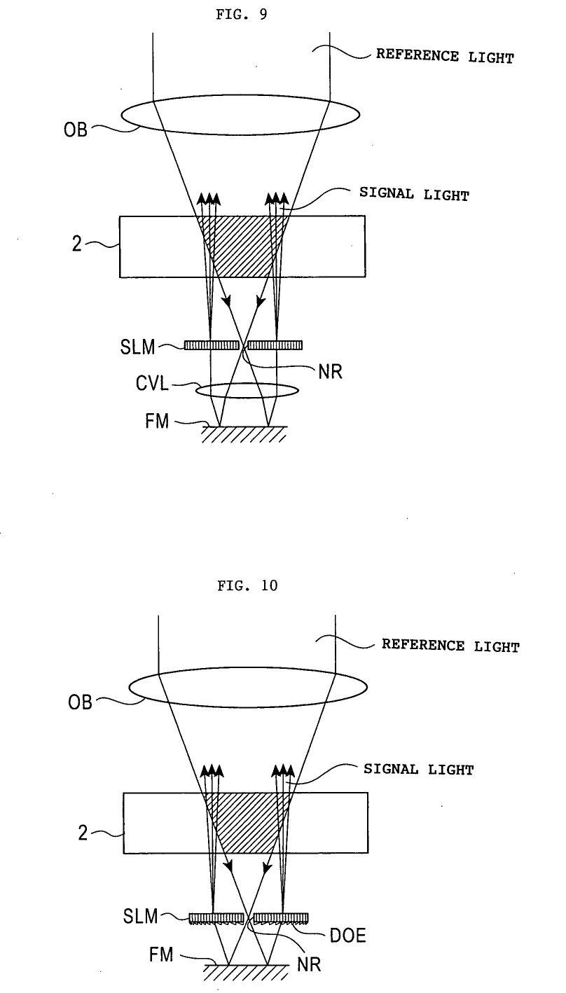

While the above embodiment uses a parabolic mirror as the concave mirror of the reflecting part for the reference light. In another embodiment, as shown in FIG. 8, the concave mirror of the reflecting part may be replaced with an assembly of a planoconvex lens PCL having a focal point FP and a flat mirror FM formed on the planar side opposite from the incident side. Moreover, as shown in FIG. 9, the reflecting part may be an assembly of a convex lens CVL having a focal point FP and a flat mirror FM which are arranged apart in parallel. Furthermore, a diffractive optical device having a convex lens function for focusing light on a focal point FP (not shown) may be used instead of the planoconvex lens PCL and the convex lens CVL. The diffractive optical device is an optical device which is composed of a transparent flat plate and a plurality of phase steps or a diffraction ring zone (rotationally symmetric configuration around the optical axis) made of convexes and concaves or brazes formed thereon, such as a diffraction grating having a convex lens function. When using a diffractive optical device, as shown in FIG. 10, the diffractive optical device DOE may be formed integrally on the periphery of the light transmission part NR of the spatial light modulator SLM, and combined with a flat mirror FM arranged apart in parallel to form an assembly of simple configuration (in the diagram, the diffractive optical device DOE is arranged on the side opposite from the objective lens, whereas it may be on the objective lens side).

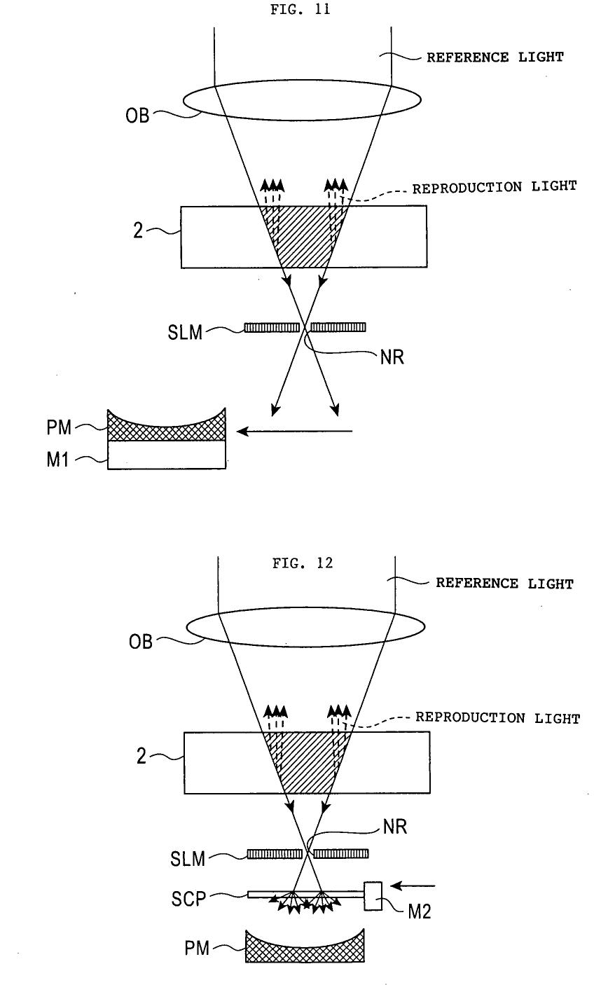

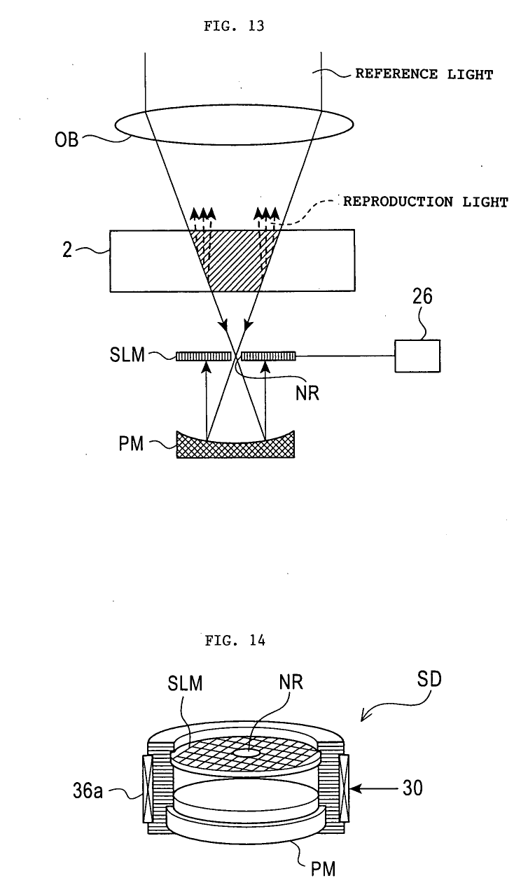

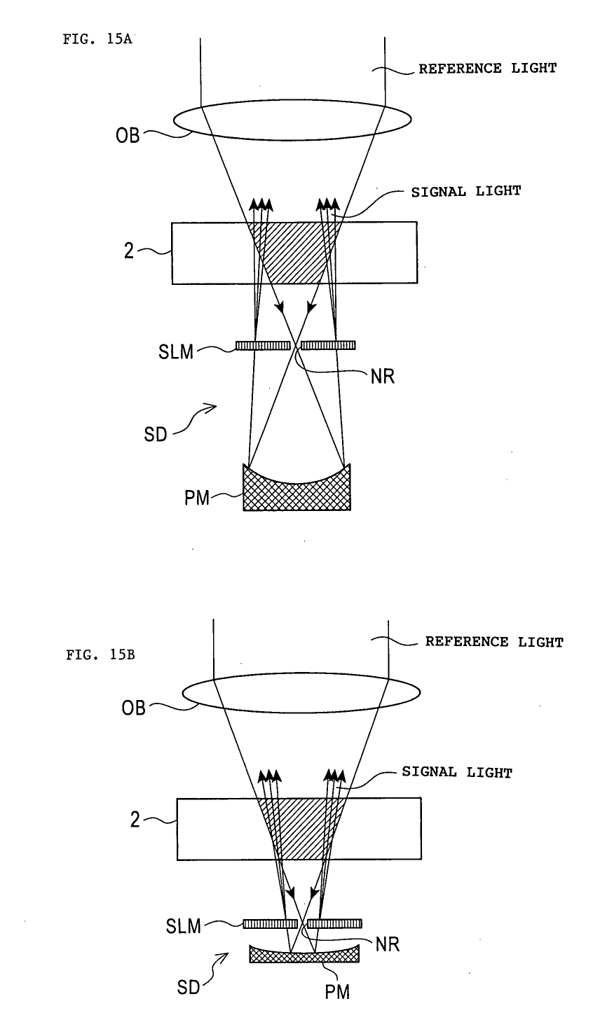

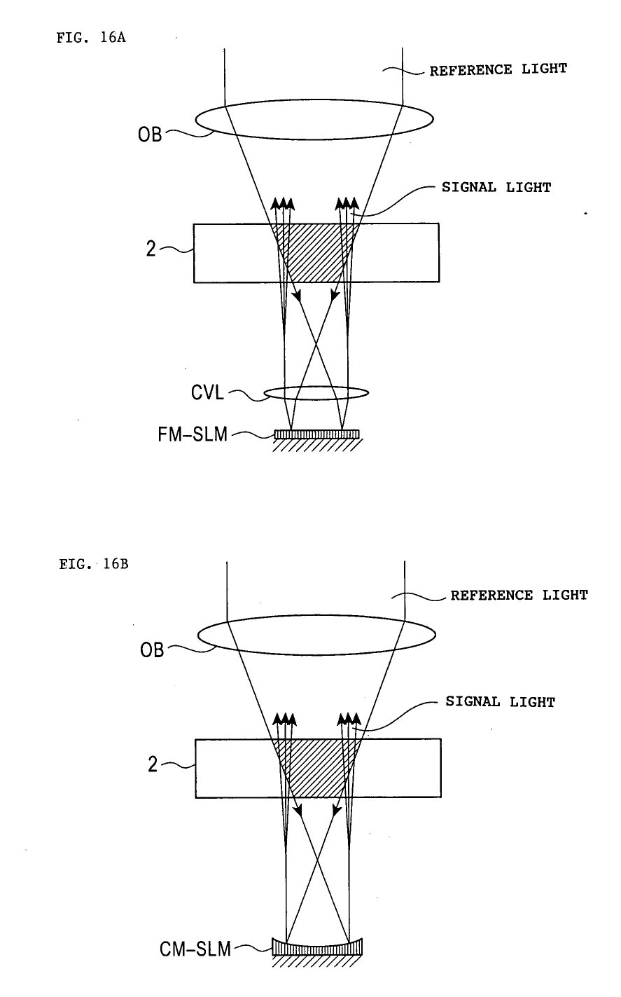

When reading a pre-recorded recording medium 2 in a read-only apparatus, the signal light optical system sOS of FIG. 4 may be omitted for the sake of simple configuration. It is one of the advantages of the present method that the read-only optical system has an extremely simple configuration. Moreover, when performing reproduction in a hologram recording or recording/reproducing apparatus, a non-reflection mechanism M1 for removing the parabolic mirror PM from the optical axis during reproduction may be provided as shown in FIG. 11, or a non-reflection mechanism M2 for inserting a shield plate or scattering plate SCP during reproduction as shown in FIG. 12. Alternatively, the pattern of the spatial light modulator SLM may be controlled by the control circuit 26 so as to make all the pixels non-transmissive to block the reference light during reproduction as shown in FIG. 13, preventing the reference light from returning to the objective lens OB.

In the embodiment, when using conversing light (spherical wave) and parallel light (plane wave) as the reference light and the signal light for opposed irradiation, respectively, then shift multiplex recording can be achieved by moving the recording medium 2 horizontally, or in a direction perpendicular to the optical axis, for overlapped recording. For example, in order to establish alignment between the optical axes of the reflecting part such as the parabolic mirror PM and the spatial light modulator SLM, the parabolic mirror PM and the spatial light modulator SLM may be fixed coaxially with the optical axis by a hollow holder as shown in FIG. 14. This allows the provision of a reflecting part driving unit 36a such as coils wound around the same, thereby contributing to the integral driving of the parabolic mirror PM and the spatial light modulator SLM. The spatial light modulator SLM arranged coaxially with the objective lens OB, the modulation-free light transmission part NR formed thereon, and the reflecting part such as the parabolic mirror PM for reflecting the reference light past the spatial light modulator SLM thus function as a spatial light modulation device SD for modulating the reflected reference light into signal light. It is advantageous during reproduction to make the spatial light modulation device SD freely movable within the pickup.

In the spatial light modulation device SD, the diameter of the light transmission part NR such as a through opening in the spatial light modulator SLM is determined in consideration of such parameters as the diameters, distances, numerical apertures, and focal lengths of the objective lens OB and the parabolic mirror PM, as well as deviations from the optical axes of these. The outer diameter of the matrix liquid crystal device around the light transmission part NR is also determined in consideration of the same parameters. While the signal light is generated as a parallel beam from the parabolic mirror PM lying behind the spatial light modulator SLM, this parallel beam has only to be directed to the objective lens OB with a second numerical aperture different from the first numerical aperture of the objective lens OB. The parabolic mirror PM may thus be modified in specification within a certain extent, for example, so that the reflected reference light converges as shown in FIG. 15A or diverges as shown in FIG. 15B. The signal light of spherical wave, converging as shown in FIG. 15A, can be used to bring the crossing angle between the beams of the signal light and reference light of spherical waves, propagating in opposite directions, close to 90° for reduced angular selectivity. This contributes to shift multiplex recording.

Instead of using the spatial light modulator and the reflecting part separately in the spatial light modulation device SD, the spatial light modulator may be integrated with the reflecting part. For example, as shown in FIG. 16A, the reflecting part may be an assembly of a convex lens CVL and a flat reflection type spatial light modulator FM-SLM, having the functions of a flat mirror FM and a spatial light modulator in combination, which are arranged apart in parallel. This configuration is such that the transmission type spatial light modulator of FIG. 9 is omitted and the flat mirror FM is replaced with the flat reflection type spatial light modulator FM-SLM in that position. Alternatively, as shown in FIG. 16B, the reflecting part may be made of a concave reflection type spatial light modulator CM-SLM which has the functions of a concave mirror (preferably a parabolic mirror) and a spatial light modulator in combination. This configuration is such that the transmission type spatial light modulator of FIG. 4 is omitted and the parabolic mirror PM is replaced with the concave reflection type spatial light modulator CM-SLM in that position. These have the advantage that the perforated transmission type spatial light modulator can be omitted for the sake of simple configuration. Nevertheless, since the distance between the objective lens OB and the reflection type spatial light modulator FM-SLM or CM-SLM does not coincide with the focal length of the objective lens OB, images are not formed on an image detector as matters stand like the other embodiments. This requires that an image sensor ISR for image detection (to be described later) be moved in the direction of the optical axis, or an optical system such as a lens be added in front of the image sensor ISR, so that the spatial light modulator forms an image on the image sensor ISR.

### CONFIGURATION EXAMPLE 1

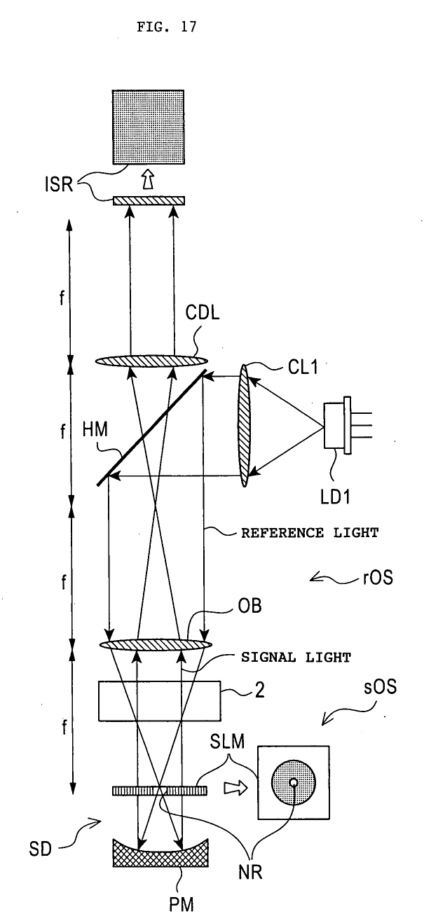

FIG. 17 shows a configuration example of essential parts of the hologram apparatus, including the reference light optical system rOS and the signal light optical system sOS which are coaxially arranged apart at opposite positions with a recording medium 2 therebetween.

The objective lens OB of the reference light optical system rOS and the spatial light modulator SLM of the signal light optical system sOS are arranged so that the distance (optical distance) therebetween is equal to the focal length f of the objective lens OB.

In the reference light optical system rOS, a condenser lens CDL having a focal length f is placed at an optical distance f from the objective lens OB, and the image sensor ISR is placed at another optical distance f from the condenser lens CDL. A half mirror HM is interposed between the objective lens OB and the condenser lens CDL so that reference light emitted from a recording/reproducing laser LD1 is turned into parallel light through a collimator lens CL1 and is reflected from the half mirror HM to the recording medium 2 through the objective lens OB.

The reference light is condensed by the objective lens OB, is transmitted through the recording medium 2, and passes the hole (light transmission part NR) in the center of the spatial light modulator SLM, which is placed near the focal plane, without modulation.

The reference light past the hole of the spatial light modulator SLM is reflected into parallel light by the parabolic mirror PM, and is transmitted through the spatial light modulator SLM, thereby being spatially modulated into signal light. Here, a black-and-white contrast pattern is displayed on the spatial light modulator SLM as an information pattern to be recorded. The signal light impinges on the recording medium 2, and interferes with the incoming reference light to form a hologram in the recording medium 2.

In this example, the display pattern on the spatial light modulator SLM forms an image on the image sensor ISR during recording. Even in the process of recording a hologram on the recording medium 2, the signal light past the recording medium 2 forms an image on the image sensor ISR through the objective lens OB and the condenser lens CDL. Formed on the image sensor ISR is thus a mixed image consisting of the image of the pattern on the spatial light modulator SLM and the reproduced image of the hologram just recorded. The image formed on this image sensor ISR here is not used in particular.

During reproduction, the reference light is blocked so as not to impinge on the recording medium 2, whereby the reproduction light of the hologram alone is reproduced from the recording medium 2.

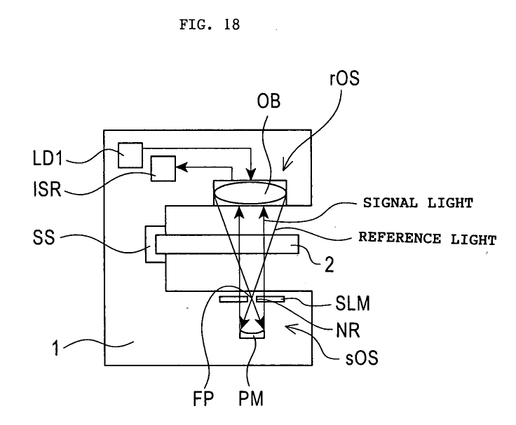

FIG. 18 is a schematic diagram of this hologram apparatus.

In the hologram apparatus 1, the reference light optical system rOS and the signal light optical system sOS are attached separately with the recording medium 2 therebetween. A suspension unit SS for holding the recording medium 2 in a freely mountable fashion is arranged so that the recording medium 2 falls between the focal point FP and the objective lens OB. The suspension unit SS is made movable in mutually-orthogonal X-, Y-, and Z-directions, while a reference light objective lens rO and a signal light objective lens sO are fixed in a mutually positioned state. If the recording medium 2 has the shape of an optical card which requires only simple positioning, then high-precision positioning such as a focus servo and a tracking servo becomes unnecessary.

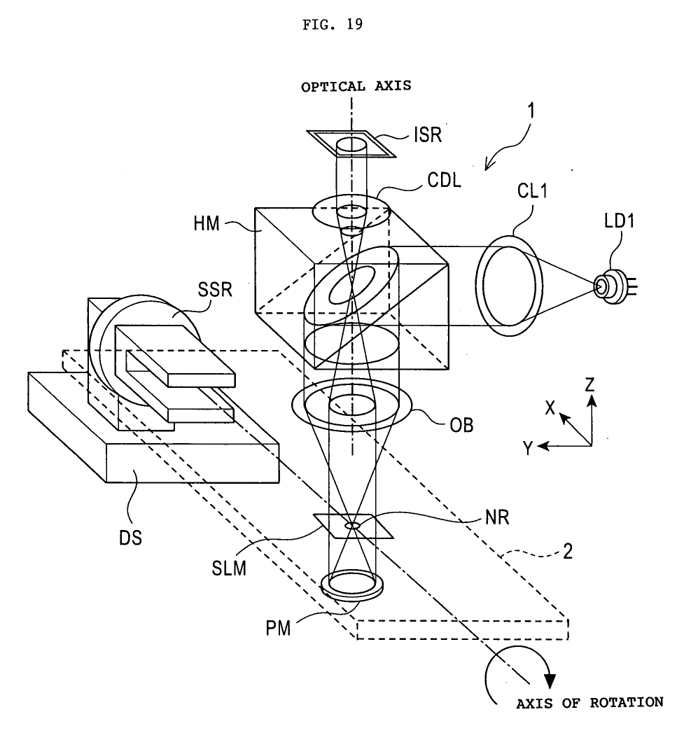

In another embodiment that is capable of shift multiplex recording, an angular multiplexing method may be adopted for this multiplex recording method. As shown in FIG. 19, the recording apparatus is configured so that a recording medium 2 is mounted on and rotatably supported by a rotating suspension unit SSR which has the axis of rotation perpendicular to the optical axis. There is also provided a drive stage DS which allows parallel movement of the suspension unit SSR in mutually-orthogonal X-, Y-, and Z-directions perpendicular to the optical axis of the optical system. By using this hologram recording/reproducing apparatus having the rotating suspension unit SSR and the drive stage DS, the medium 2 can be rotated about the axis perpendicular to the optical axis for angular multiplex hologram recording.

### OTHER EMBODIMENTS

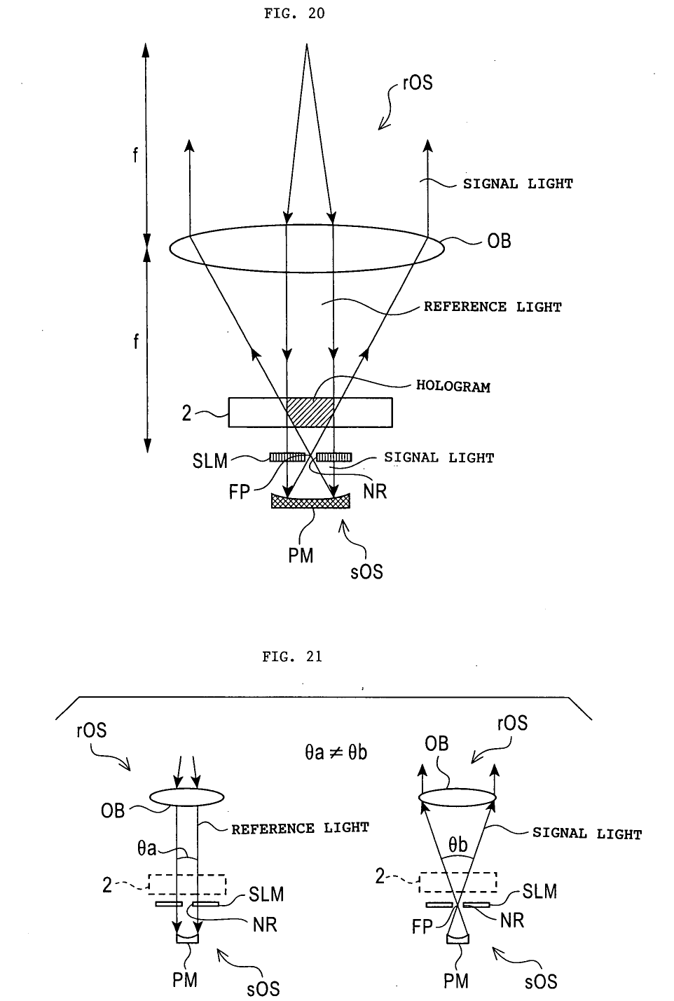

The optical system according to the embodiment of FIG. 4 has been configured so that conversing reference light is supplied from the reference light optical systems rOS to the signal light optical system sOS which are arranged apart on an identical optical axis at opposite positions with the recording medium 2 therebetween. An embodiment shown in FIG. 20 may be configured so that parallel reference light (plane wave) is supplied from the reference light optical system rOS to the signal light optical system sOS.

The reference light optical system rOS includes an objective lens OB which makes diverging light (reference light) into generally parallel light. As shown in FIG. 21, the objective lens OB emits the reference light from its effective diameter to the recording medium 2 and the signal light optical system sOS with a first numerical aperture (sin θa) (θa=0 for parallel light).

In the signal light optical system sOS, the spatial light modulator SLM of transmission type, placed on the focal point FP of the objective lens OB, is the same as that of the foregoing embodiment. It has a light transmission part NR in the center including its optical axis, and is configured so that signal light focused onto the light transmission part NR by a parabolic mirror PM passes through without modulation. The parallel light transmitted through the recording medium 2 is modulated by the spatial light modulator SLM.

That is, as in the foregoing embodiment, the parabolic mirror PM is coaxially arranged on the side opposite from the incidence side of the spatial light modulator SLM so that its focus coincides with the focal point FP of the objective lens OB. The parabolic mirror PM reflects the signal light of plane wave, transmitted through the spatial light modulator SLM, as a converging beam of spherical wave.

The signal light optical system sOS is arranged so that the converging beam from the parabolic mirror PM passes through the light transmission part NR of the spatial light modulator SLM and returns to the recording medium 2 and the objective lens OB of the reference light optical system rOS as a diverging beam of signal light.

Consequently, in the optical systems, as shown in FIG. 21, the parabolic mirror PM and the spatial light modulator SLM generate signal light by spatially modulating the parallel beam of reference light according to recording information, and make it pass through the recording medium 2 with a second numerical aperture different from the first numerical aperture of the objective lens OB (sin θb≠sin θa) in the direction opposite from the reference light. Because of the reflecting part behind the spatial light modulator SLM, the signal light thus passes through the recording medium 2 to the objective lens OB with the second numerical aperture that is different, e.g., greater than the first numerical aperture.

As shown in FIGS. 20 and 21, during recording, the recording medium 2 is irradiated with the parallel beam of reference light from the objective lens OB. The reference light past the recording medium 2 is without modulation and transmitted through the spatial light modulator SLM, thus modulated into signal light according to the recording information. The parallel signal light is reflected by the parabolic mirror PM into converging light, and is focused onto the light transmission part NR of the spatial light modulator SLM to make diverging light. The recording medium 2 is irradiated with the diverging signal light, which interferes with the incoming reference light of plane wave inside the recording medium 2 for hologram recording. The light transmission part NR of the spatial light modulator SLM has no effect on the signal light.

For reproduction, non-reflection means for stopping the function of the reflecting part such as the parabolic mirror PM so as not to reflect the reference light is provided. It is then possible to irradiate the surface side of the recording medium 2 with the reference light of plane wave and obtain reproduction light of spherical wave from the same side without being hindered by the reference light.

In this embodiment, the reference light consists of plane waves, and the signal light consists of spherical waves. This makes it possible to secure some crossing angle between the beams of the reference light and the signal light, being suited to shift multiplex recording.

### CONFIGURATION EXAMPLE 2

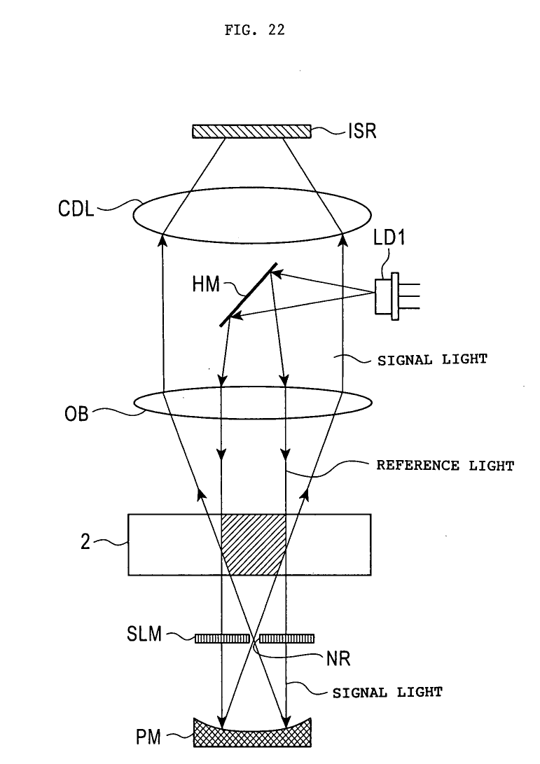

FIG. 22 shows a configuration example of the hologram apparatus including a reference light optical system rOS and a signal light optical system sOS which are coaxially arranged apart at opposite positions with a recording medium 2 therebetween.

The objective lens OB of the reference light optical system rOS and the spatial light modulator SLM of the signal light optical system sOS are arranged at a distance equal to the focal length of the objective lens OB.

In the reference light optical system rOS, a condenser lens CDL is coaxially arranged on the side of the recording layer 2 opposite from the objective lens OB, and an image sensor ISR is placed in the image forming position of the condenser lens CDL. A half mirror HM is interposed between the objective lens OB and the condenser lens CDL so that the reference light emitted from the recording/reproducing laser LD1 (being placed at the focal point if the objective lens OB is used as a collimator; divergent laser light such as becomes parallel light through the objective lens OB may be generated with a separate optical system) is reflected by the half mirror HM and travels to the recording medium 2 as parallel light through the objective lens OB.

The reference light is turned into parallel light through the objective lens OB, is transmitted through the recording medium 2, and is transmitted through the spatial light modulator SLM, thereby being spatially modulated into signal light. Here, a black-and-white contrast pattern is displayed on the spatial light modulator SLM as an information pattern to be recorded. The parallel signal light is reflected by the parabolic mirror PM into converging light, and passes the hole (being the light transmission part NR) in the center of the spatial light modulator SLM, which is placed near the focal plane, without modulation.

The diverging signal light past the hole of the spatial light modulator SLM impinges on the recording medium 2, and interferes with the incoming parallel reference light to form a hologram in the recording medium 2.

During reproduction, the reference light is blocked so as not to impinge on the recording medium 2, whereby the reproduction light of the hologram alone is reproduced from the recording medium 2.

Using the spatial light modulation device SD and the reference light of plane wave, this embodiment can utilize conventional pickups. This results in an extremely simple configuration, which is one of the advantages of the present method.

<Hologram Apparatus for Disk-Like Recording Medium>

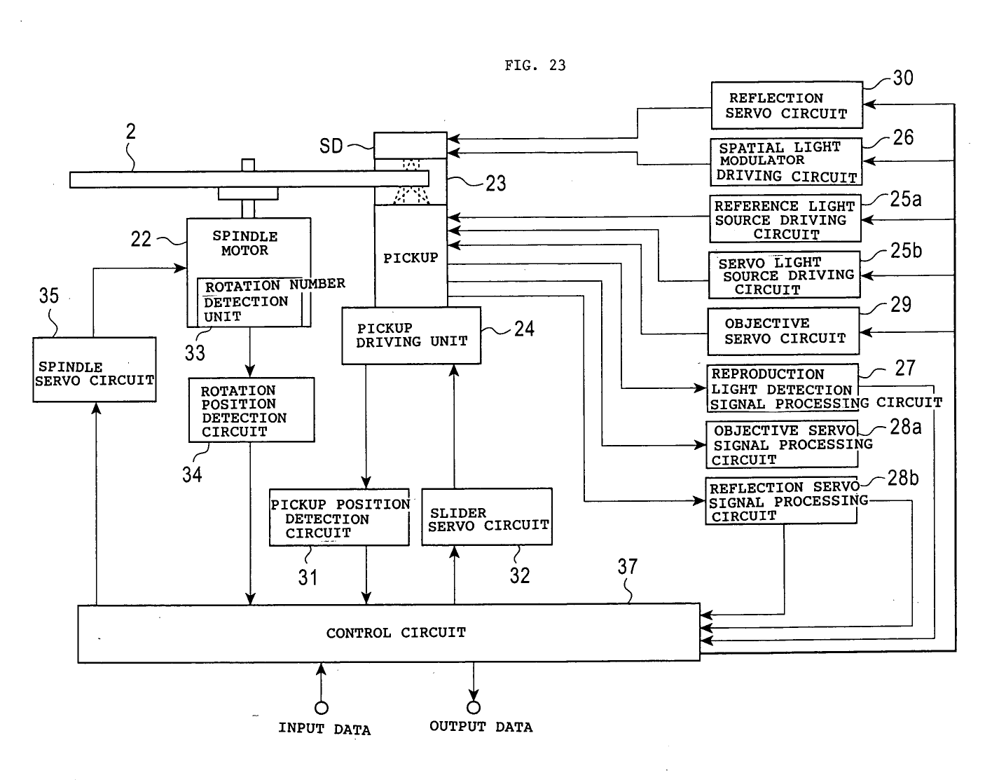

FIG. 23 shows an example of general configuration of a hologram apparatus for recording or reproducing information on/from a disk-like hologram recording medium (disk) 2 to which the present invention is applied.

The hologram apparatus comprises: a spindle motor 22 which rotates the disk 2 via a turntable; a pickup 23 (being integral with the spatial light modulation device SD, whereas they may be separate members) which reads signals from the recording medium 2 by means of light beams; a pickup driving unit 24 which holds the pickup and moves it in a radial direction (being an x-direction); a reference light source driving circuit 25a; a servo light source driving circuit 25b; a spatial light modulator driving circuit 26; a reproduction light signal detection circuit 27; an objective servo signal processing circuit 28a; a reflection servo signal processing circuit 28b; an objective servo circuit 29; a reflection servo circuit 30; a pickup position detection circuit 31 which is connected to the pickup driving unit 24 and detects a position signal of the pickup; a slider servo circuit 32 which is connected to the pickup driving unit 24 and supplies predetermined signals thereto; a rotation number detection unit 33 which is connected to the spindle motor 22 and detects a rotation number signal of the spindle motor; a rotation position detection circuit 34 which is connected to the rotation number detection unit and generates a rotation position signal of the disk 2; and a spindle servo circuit 35 which is connected to the spindle motor 22 and supplies predetermined signals thereto.

The hologram apparatus has a control circuit 37. The control circuit 37 is connected with the reference light source driving circuit 25a, the servo light source driving circuit 25b, the spatial light modulator driving circuit 26, the reproduction light signal detection circuit 27, the objective servo signal processing circuit 28a, the objective servo circuit 29, the reflection servo circuit 30, the pickup position detection circuit 31, the slider servo circuit 32, the rotation number detection unit 33, the rotation position detection circuit 34, and the spindle servo circuit 35. Based on signals from these detection circuits, the control circuit 37 exercises a movement servo control on the pickup in x-(track-perpendicular), y-(track-parallel), and z-(focus) directions and a control on reproduction position (positions in x- and y-directions) of the pickup through the foregoing driving circuits. The control circuit 37 is composed of a microcomputer which implements various types of memories, and exercises control on the entire apparatus. It generates various control signals depending on user's operation inputs from an operation unit (not shown) and the current operating status of the apparatus, and is connected to a display unit (not shown) for displaying the operating status and the like to the user.

The control circuit 37 also executes processing such as encoding of externally-input data to be recorded as a hologram, and supplies predetermined signals to the spatial light modulator driving circuit 26 to control the recording sequence of the hologram. The control circuit 37 performs demodulation and error correction processing based on signals from the reproduction light signal detection circuit 27, thereby reconstructing data recorded on the disk 2. Moreover, the control circuit 37 applies decoding processing to the reconstructed data to reproduce information data, and outputs it as reproduction information data.

Furthermore, the control circuit 37 generates a slider driving signal based on a position signal from the operation unit or the pickup position detection circuit 31 and an x-direction movement error signal from the objective servo signal processing circuit 28a, and supplies it to the slider servo circuit 32. Through the pickup driving unit 24, the slider servo circuit 32 makes the pickup 23 move in the radial direction of the disk in accordance with a driving current corresponding to the slider driving signal.

The rotation number detection unit 33 detects a frequency signal which indicates the current frequency of rotation of the spindle motor 22 for rotating the disk 2 on the turntable, generates a rotation number signal indicating the corresponding number of spindle rotations, and supplies it to the rotation position detection circuit 34. The rotation position detection circuit 34 generates a rotation number position signal and supplies it to the control circuit 37. The control circuit 37 generates a spindle driving signal and supplies it to the spindle servo circuit 35, thereby controlling the spindle motor 22 to drive the disk 2 rotationally.

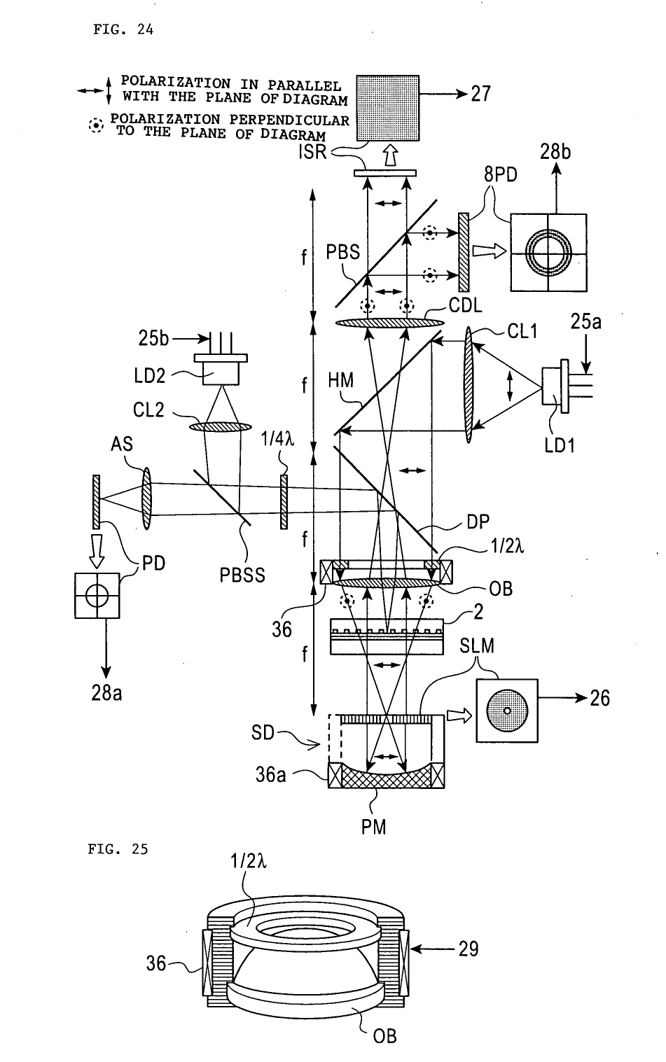

FIG. 24 shows the schematic configuration of the pickup of the hologram apparatus.

The pickup 23 comprises a reference light optical system as the irradiation optical system, and a spatial light modulation device SD as the signal light optical system, which is arranged apart in an opposed position on the optical axis of the same and includes a reflecting part for reflecting the reference light back to the irradiation optical system. The disk 2 is interposed between the irradiation optical system and the spatial light modulation device SD.

The irradiation optical system comprises: a recording/reproducing laser LD1 intended for reference light; a collimator lens CL1; a half mirror HM; an objective lens OB for condensing reference light toward the spatial light modulation device SD with a first numerical aperture; a condenser lens CDL; and an image sensor ISR composed of an array of CCD (charge coupled devices), CMOS (complementary metal oxide semiconductors), or the like. The objective lens OB and the spatial light modulation device SD are arranged on the case of the pickup 23 so as to be freely drivable.

The recording/reproducing laser LD1 is connected to the reference light source driving circuit 25a, and is adjusted in output by the circuit so as to emit reference light at a high intensity during hologram recording and at a low intensity during reproduction. An objective servo photodetector PD is connected to the servo light source driving circuit 25b.

The image sensor ISR is connected to the reproduction light signal detection circuit 27.

The spatial light modulation device SD includes a spatial light modulator SLM and a reflecting part such as a parabolic mirror PM. The spatial light modulator SLM has a light transmission part NR, or non-modulation area, which is positioned coaxially with the objective lens OB. The parabolic mirror PM reflects the reference light past the same. As shown in FIG. 14, the parabolic mirror PM and the spatial light modulator SLM are fixed coaxially with the optical axis by a hollow holder. Coils or the like are wound around to form a reflecting part driving unit 36a. The spatial light modulator SLM has the functions of interrupting part of incident light or transmitting all the light for a non-reflecting state electrically by such means as a liquid crystal panel having a matrix of a plurality of split transparent pixel electrodes. This spatial light modulator SLM is connected to the spatial light modulator driving circuit 26, and generates signal light by spatially modulating a light beam so as to have a distribution based on supplied page data to be recorded (two-dimensional data on an information pattern such as a contrast dot pattern on a plane). The spatial light modulation device SD receives the reference light of the first numerical aperture, generates signal light from the same, and makes the light pass through the disk 2 with a second numerical aperture different from the first numerical aperture.

The irradiation optical system is provided with an objective servo system for exercising position control on the objective lens OB and a reflection servo system for exercising position control on the spatial light modulator SD.

<Objective Servo System>

The objective servo system comprises an objective servo signal detection unit and the objective lens driving unit 36. The objective servo signal detection unit includes a servo laser LD2, a convex lens CL2, a polarizing beam splitter PBS, a quarter-wave plate ¼λ, a dichroic prism DP, a detection lens AS, and the objective servo photodetector PD. The objective lens driving unit 36 moves the objective lens OB in a direction parallel to its optical axis (being the z-direction), a direction parallel to the track (being the y-direction), and a direction perpendicular to the track (being the x-direction) based on the photoelectrically-converted outputs from the objective servo photodetector PD, for the sake of exercising a servo control on the position of the light beam with respect to the disk 2.

The objective servo photodetector PD is connected to an objective lens servo unit of the objective servo signal processing circuit 28a. For example, it has photoreceptor devices intended for focus servo, x-direction movement servo, and y-direction movement servo, respectively. Each of the output signals from the objective servo photodetector PD is supplied to the objective servo signal processing circuit 28a.

The objective servo signal processing circuit 28a generates driving signals based on error signals obtained by calculation from the outputs of the objective servo photodetector PD, and supplies them to the control circuit 37. The control circuit 37 supplies the driving signals to the objective servo circuit 29, and the objective servo circuit 29 drives a triaxial actuator (being the objective lens driving unit 36) in accordance with the driving signals. This realizes triaxial positioning of the disk 2 in x-, y-, and z-directions by using a servo beam, during hologram recording and reproduction as well.

For example, z-direction servo (focus servo) control may be performed by using an astigmatic method, spot size method, or the like used in ordinary pickups, or a combination of these. When using the astigmatic method, for example, a four-way split photodetector and an astigmatic optical device are used. The photoreceptor part of the four-way split photodetector is composed of four independent photoreceptor devices which are arranged next to each other with two orthogonal parting lines as borders and receive beam components that pass through a ring zone around the intersection of the parting lines. Examples of the astigmatic optical device include a cylindrical lens and an oblique-incidence transparent plate. In this case, the servo signal processing circuit generates a focus error signal on distance by determining a difference between the sum of the outputs of two photoreceptor devices lying at diagonal positions, out of the four photoreceptor devices, and the sum of the outputs of the other two.

<Reflection Servo System>

The reflection servo system comprises a half-wave plate ½λ, a reflection servo photodetector 8PD, a polarizing beam splitter PBS, and the reflecting part driving unit 36a of the spatial light modulation device SD. FIG. 24 shows the foregoing optical components as arranged almost correspondingly, though not restrictive.

The half-wave plate ½λ is a phase plate having a ring zone, and is fixed to the objective lens OB. It gives an annular phase difference to beam components of the reference light passing through its effective diameter and the proximity. As shown in FIG. 25, the half-wave plate ½λ and the objective lens OB are fixed coaxially with the optical axis by a hollow holder. Coils or the like are wound around to make the objective lens driving unit 36.

The polarizing beam splitter PBS is arranged on the optical axis of the irradiation optical system. It extracts beam components of the return light that pass through the ring zone, and introduces the same to the reflection servo photodetector 8PD.

The photoreception part of the reflection servo photodetector 8PD is composed of mutually-independent four center photoreceptor devices and four outer photoreceptor devices. The center photoreceptor devices are arranged next to each other with two orthogonal parting lines (in x- and y-directions) as borders, and receive beam components that pass through a ring zone around the intersection of the parting lines. The outer photoreceptor devices are arranged next to each other, outside the respective center photoreceptor devices.

The reflection servo signal processing circuit 28b in connection with the reflection servo photodetector 8PD generates an error signal on distance between the objective lens OB and the reflecting part by determining a difference between the sum of the outputs of the four center photoreceptor devices and the sum of the outputs of the four outer photoreceptor devices. In the meantime, it also generates a deviation error signal of the reflecting part with respect to the optical axis by determining a difference between the sum of the outputs of two center photoreceptor devices and two outer photoreceptor devices that fall on one of the two sections divided by one of the two parting lines, among the four center photoreceptor devices and the four outer photoreceptor devices, respectively, and the sum of the outputs of the others. These signals are supplied to the control circuit 37. The control circuit 37 drives the reflection part driving unit 36a of the spatial light modulation device SD in x-, y-, and z-directions via the objective servo circuit 29 by using x-, y-, and z-direction movement driving signals. That is, the reflection part driving unit 36a of the spatial light modulation device SD moves the spatial light modulation device SD in x-, y-, and z-directions based on the photoelectrically-converted outputs from the reflection servo photodetector 8PD. As a result, the spatial light modulation device SD is driven in accordance with driving currents specified by the x-, y-, and z-direction driving signals. This can maintain the spatial light modulation device SD at a constant relative position with respect to the objective lens OB, thereby securing time for hologram formation.

In this way, the reflecting part driving unit 36a utilizes part of the signal light to exercise positional control on the spatial light modulation device SD with respect to the objective lens OB (correction on distance and optical axis deviation).

<Reflecting Part Driving Unit>

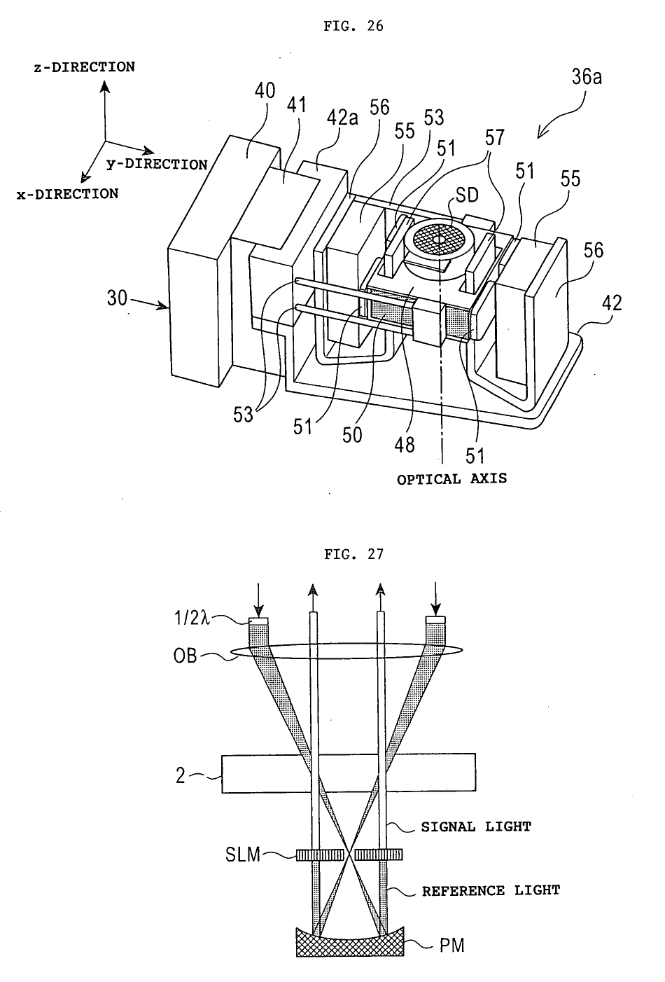

FIG. 26 shows the reflecting part driving unit 36a of the reflecting part intended for the hologram apparatus of the embodiment.

The reflecting part driving unit 36a has an actuator base 42 capable of being vibrated in y-direction by a piezo element 41 which is attached to a support unit 40 fixed on a reflecting part body (not shown).

The spatial light modulation device SD, including the parabolic mirror PM and the spatial light modulator SLM, is mounted inside a holder 48. A z-direction coil 50 is wound around the periphery of the holder 48 so that the center axis of the coil is in parallel with the optical axis of the parabolic mirror PM. Four x-direction coils 51 are attached to the outer side of the z-direction coil 50, for example, so that the center axes of the coils are perpendicular to the optical axis of the parabolic mirror PM. The x-direction coils 51 are each formed by pasting a coil annularly wound in advance onto the z-direction coil 50. The holder 48 is supported by ends of four longitudinal support members 53. It should be appreciated that the diagram shows only three of the support members 53. The four longitudinal support members 53 are composed of two pairs, in each of which support members 53 are arranged apart in the direction of the optical axis of the parabolic mirror PM so as to extend in y-direction perpendicular to the direction of the optical axis of the parabolic mirror PM. Each support member 53 is attached to a protruded part 42a fixed on the actuator base 42, at the other end in a cantilevered fashion. The supporting members 53 are flexible, being made of coil material or the like. The four longitudinal support members 53 and the piezo element 41 mentioned above allow free movement of the spatial light modulation device SD including the parabolic mirror PM in x-, y-, and z-directions.

The holder 48 is spaced from and interposed between a pair of magnetic circuits. Each magnetic circuit is composed of a magnet 55 facing the holder 48 and a metal plate 56 for supporting the same, and is fixed onto the actuator base 42. A pair of through holes are formed in sides of the holder 48. The pair of through holes are located inside of the z-direction coil 50 of the holder 48 in the extending direction of the longitudinal support members 53, so as to be in parallel with the center axis of the coil and the optical axis of the parabolic mirror PM, with the parabolic mirror PM therebetween. Yokes 57 extended from the metal plates 56 of the magnetic circuits are inserted into the respective through holes without contact. That is, the z-direction coil 50 and the x-direction coils 51 lie in the magnetic gaps of the magnetic circuits composed of the magnets 55 and the yokes 57.

The z-direction coil 50, the x-direction coils 51, and the piezo element 41 are controlled by the reflection servo circuit 30 which supplies z-, x-, and y-direction driving signals thereto, respectively. The magnetic gaps can cause parallel magnetic fluxes orthogonally linked to the coils. Predetermined currents can thus be supplied to the respective coils so that driving forces occur in x- and z-directions to drive the foregoing movable optical systems in the respective directions.

As above, the parabolic mirror PM is driven in x- and y-directions by using voice coil motors. In y-direction, the entire actuator base is driven by using the piezo element or the like. Aside from this structure, the driving unit may also use voice coil motors for all the axes aside.

<Operation of the Hologram Apparatus>

As shown in FIG. 24, the reference light emitted from the recording/reproducing laser LD1 of wavelength λ1 is linearly polarized with its polarization direction in parallel with the plane of the diagram. The reference light is collimated through the collimator lens CL1, and is reflected from the half mirror HM toward the objective lens OB and the disk 2. The dichroic prism DP is configured to transmit the reference light of λ1, and to reflect light of wavelength λ2 from the servo laser LD2. The reference light is thus simply transmitted through the dichroic prism DP.

The half-wave plate ½λ of ring shape is arranged immediately in front of the objective lens OB. The reference light is thus linearly polarized so that its peripheral light alone has a direction of polarization perpendicular to the plane of the diagram. The reference light is condensed by the objective lens OB, is transmitted through the disk 2, and passes through the spatial light modulator. SLM placed near the focal plane without modulation since a hole (light transmission part NR) is formed in the center. This hole may have a certain larger diameter in consideration of the diameters of the objective lens OB and the parabolic mirror PM and deviations from the optical axes thereof.

The reference light past the hole of the spatial light modulator SLM is reflected from the parabolic mirror PM into parallel light, and is transmitted through the spatial light modulator SLM around the light transmission part NR, thereby being spatially modulated into signal light. Here, a black-and-white contrast pattern is displayed on the spatial light modulator SLM as an information pattern to be recorded. The signal light impinges on the disk 2, and interferes with the incoming reference light to form a hologram in the recording layer of the disk 2.

The objective lens OB and the spatial light modulator SLM are arranged at a distance (optical distance) equal to the focal length f of the objective lens OB. The condenser lens CDL having a focal length f is placed at an optical distance f from the objective lens OB on a side opposite from the disk 2, and the image sensor ISR and the reflection servo photodetector 8PD are placed at another optical distance f from the condenser lens CDL. Moreover, the polarizing beam splitter PBS is interposed between the condenser lens CDL and the image sensor ISR so as to transmit P-polarized light with respect to the 45° splitting surface and reflect S-polarized light. The reference light is polarized in parallel with the plane of the diagram, i.e., P-polarized with respect to this plane, and thus directed to the image sensor ISR. Note that light components that are transmitted through the half-wave plate ½λ are S-polarized, and thus are reflected toward the reflection servo photodetector 8PD. In this arrangement, the display pattern on the spatial light modulator SLM simply forms an image on the image sensor ISR. Even in the process of recording a hologram on the disk 2, the signal light past the disk 2 forms an image on the image sensor ISR through the objective lens OB and the condenser lens CDL. Formed on the image sensor ISR is thus a mixed image consisting of the image of the pattern on the spatial light modulator SLM and the reproduced image of the hologram just recorded.

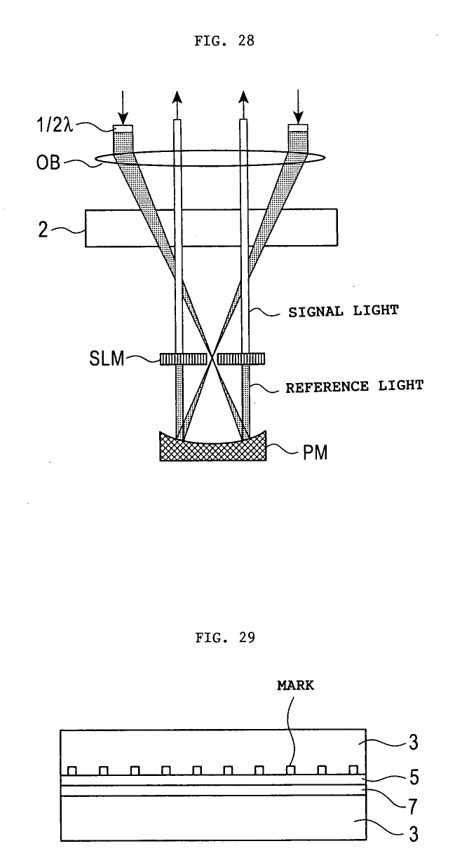

The peripheral light affected by the half-wave plate ½λ and the inner light unaffected are linearly polarized in 90° different directions, and thus will not interfere with each other. Possible holograms to be recorded on the disk 2 include an interference pattern between the inner beams of reference light past the inside of the ring and an interference pattern between the peripheral beams of reference light past the ring area. It should be appreciated that the interference pattern between the peripheral beams of reference light may be excluded from recording on the disk 2 by adjusting the position of the disk 2 so that the reference light has a beam diameter sufficiently smaller than that of the signal light. For example, as shown in FIG. 27, an annular hologram is recorded in the disk 2 where the peripheral beams of reference light overlap. Then, as shown in FIG. 28, the disk 2 can be shifted toward the objective lens OB so that the beams of reference light do not overlap with each other inside the disk 2, thereby precluding hologram recording. The former configuration is used in common. The latter can provide an index for reproduction since the hologram created by the interference pattern between the inner beams of reference light is enclosed in an annular unrecorded blank.

During reproduction, the reference light is blocked by non-reflection means so as not to impinge on the disk 2, whereby the reproduction light of the hologram alone is reproduced from the disk 2. An interference pattern between the inner beams of reference light is reproduced by inner light from the half-wave plate ½λ and is transmitted through the polarizing beam splitter PBS, and the reproduction signal forms an image on the image sensor ISR. An interference pattern between the peripheral beams of reference light is reproduced by light transmitted through the half-wave plate ½λ, is reflected by the polarizing beam splitter PBS, and forms an image on the reflection servo photodetector 8PD. Since the reproduction light is generally parallel light, it passes through the inside of the ring-shaped half-wave plate ½λ without being affected by the half-wave plate ½λ. It is therefore preferable that the light beam be returned through the inside of the ring zone of the half-wave plate ½λ.

The servo laser LD2 having a wavelength different from that of the recording/reproducing laser LD1 plays the role of generating a servo signal which is used to drive the objective lens OB so that the objective lens OB and the disk 2 come to a predetermined relative position. It should be appreciated that the focal point of the servo beam and the focal point of the recording/reproducing laser LD1 shall be adjusted to a predetermined distance. The light of linear polarization emitted from the servo laser LD2 is slightly converged through the convex lens CL2, and impinges on a polarizing beam splitter PBSS. This servo beam is S-polarized with respect to the splitting surface of the polarizing beam splitter PBSS. It is thus reflected, is circularly polarized through the quarter-wave plate ¼λ, and impinges on the dichroic prism DP. Having a wavelength of λ2, the servo beam is reflected toward the disk 2. The servo beam is given a beam diameter as small as can be passed through the inside of the half-wave plate ½λ, and thus impinges on the objective lens OB without being affected by the half-wave plate ½λ. The objective lens OB condenses the servo beam to the disk 2.

The disk 2 has such a sectional structure as shown in FIG. 29, consisting of a wavelength selective reflecting layer 5 and a hologram recording layer 7 which are sandwiched between a pair of substrates 3, for example. The hologram recording layer 7 for storing optical interference patterns is made of a photosensitive material such as a photorefractive material, a hole burning material, and a photochromic material. The wavelength selective reflecting layer 5 on the light irradiation side is made of a metal film, as well as a phase change film, a pigmented film, or a combination of these, for example. It is configured to transmit light at the wavelength of the reference light and reflect light at the wavelength of the servo beam alone. The substrates 3 are made of such materials as glass, plastics including polycarbonate, amorphous polyolefin, polyimide, PET, PEN, and PES, and ultraviolet curing acrylic resins. The principle surface of the wavelength selective reflecting layer 5 is provided with markings for servo beam tracking, such as tracks and pits.

The servo beam condensed through the objective lens OB is reflected by the wavelength selective reflecting layer 5 (recording medium 2) to return the same path. It passes through the quarter-wave plate ¼ again for linear polarization (with a direction of polarization 90° different from when emitted), is transmitted through the polarizing beam splitter PBS, and is introduced to the objective servo photodetector PD via the detection lens AS.

Based on signals from the objective servo photodetector PD, the objective lens OB is moved in the direction of the optical axis (focus servo) so that the wavelength selective reflecting layer 5 comes to the focal point of the servo beam, and is moved in a direction perpendicular to the optical axis (tracking servo) so that a servo mark falls on the condensed point. This method is exactly the same as in the servo technologies for conventional optical disks. For example, the astigmatic method may be used for focus servo, and the push-pull method may be used for tracking servo.

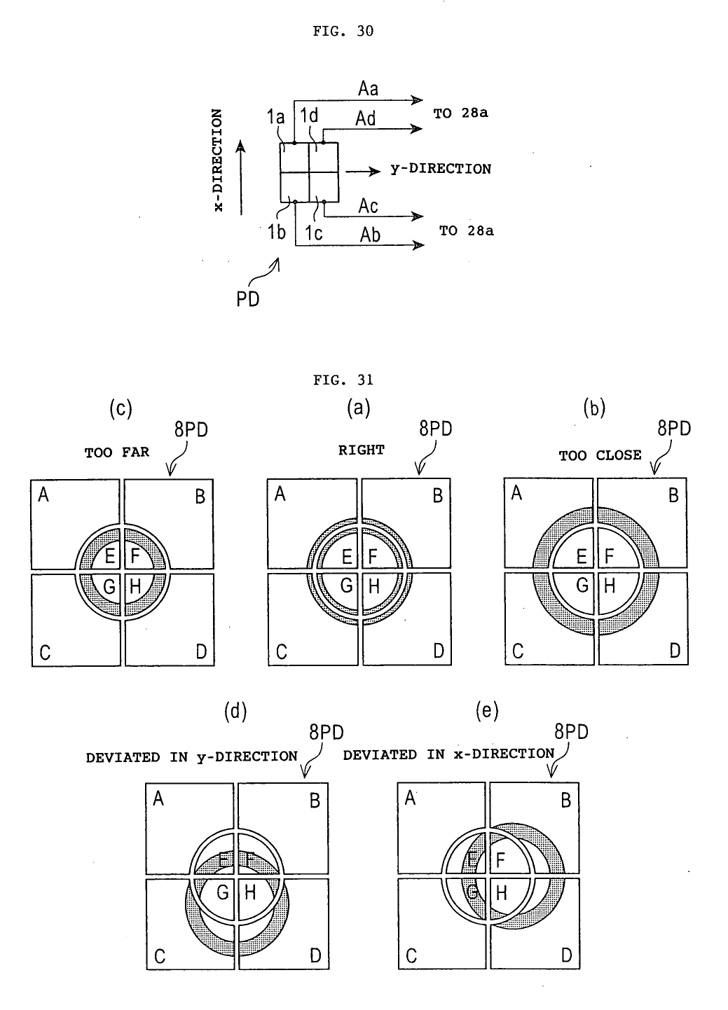

With the astigmatic method, for example, a four-way split photodetector (objective servo photodetector PD) and an astigmatic optical device (not shown) are used. As shown in FIG. 30, the center one of the objective servo photodetector PD, or the four-way split photodetector, has photoreceptor devices 1a to 1d with four equally-divided photoreceptive surfaces intended for beam reception. The directions of the four-way parting lines correspond to the disk radial direction and the track tangent direction. The objective servo photodetector PD is configured so that a light spot, when focused, forms a circle about the splitting and crossing center of the photoreceptor devices 1a to 1d.

The objective servo signal processing circuit 28a generates various types of signals according to the output signals of the respective photoreceptor devices 1a to 1d of the four-way split photodetector. The output signals of the photoreceptor devices 1a to 1d shall be referred to as Aa to Ad, respectively. A focus error signal FE is then calculated as FE=(Aa+Ac)−(Ab+Ad). A tracking error signal TE is calculated as TE=(Aa+Ad)−(Ab+Ac). These signals are supplied to the objective servo signal processing circuit 28a. This makes it possible to maintain the recording medium 2 and the objective lens OB at an appropriate distance and appropriate positions.

To make an adjustment to the relative position between the objective lens OB and the parabolic mirror PM, an annular beam past the ring-shaped half-wave plate ½λ is utilized. As mentioned above, this annular beam is introduced onto the reflection servo photodetector 8PD. This reflection servo photodetector 8PD is divided into eight parts as shown in FIG. 31. When the parabolic mirror PM is in a proper position, a ring-shaped beam pattern RP falls on the circular parting line as shown in FIG. 31A. Here, the photoreceptor devices on the outer sides (A+B+C+D) of the reflection servo photodetector 8PD and those on the inner sides (E+F+G+H) are identical in the amount of light. When the parabolic mirror PM approaches the objective lens OB, the photoreceptor devices on the outer sides increase in the amount of light as shown in FIG. 31B. When the parabolic mirror PM gets away from the objective lens OB, on the other hand, the photoreceptor devices on the inner sides increase in the amount of light as shown in FIG. 31C. It is therefore possible to maintain the parabolic mirror PM and the objective lens OB at an appropriate distance by adjusting the position of the parabolic mirror PM in the direction of the optical axis so that an error signal FES=(A+B+C+D)−(E+F+G+H) in the optical axis direction (z-direction) comes to zero level.

When the parabolic mirror PM is deviated in a direction perpendicular to the optical axis (x- or y-direction), the ring-shaped beam pattern on the reflection servo photodetector 8PD shifts as shown in FIG. 31D or 31E. Then, the parabolic mirror PM can be adjusted in x- and y-directions so that respective error signals come to zero level, i.e., an error signal TRKy=(A+B+E+F)−(C+D+G+H) when the parabolic mirror PM is deviated in y-direction, and an error signal TRKx=(A+C+E+G)−(B+D+F+H) when the parabolic mirror PM is deviated in x-direction. Instead of the foregoing TRKy and TRKx, TRKy=(A+B+G+H)−(C+D+E+F) and TRKx=(A+C+F+H)−(B+D+E+G) may be used.

When the parabolic mirror PM is tilted, adjustments can also be made in x- and y-directions so that the error signals come to zero level. Even if the tilt or deviation of the parabolic mirror PM is yet to be zero, the pattern of the spatial light modulator SLM practically forms an image on the image sensor ISR properly without any problems if such a spot as shown in FIG. 31A appears on the reflection servo photodetector 8PD. These signals are supplied to the reflection servo signal processing circuit 28b, though the wiring is omitted from the diagrams.

<Recording/Reproducing Operation of the Hologram Apparatus>

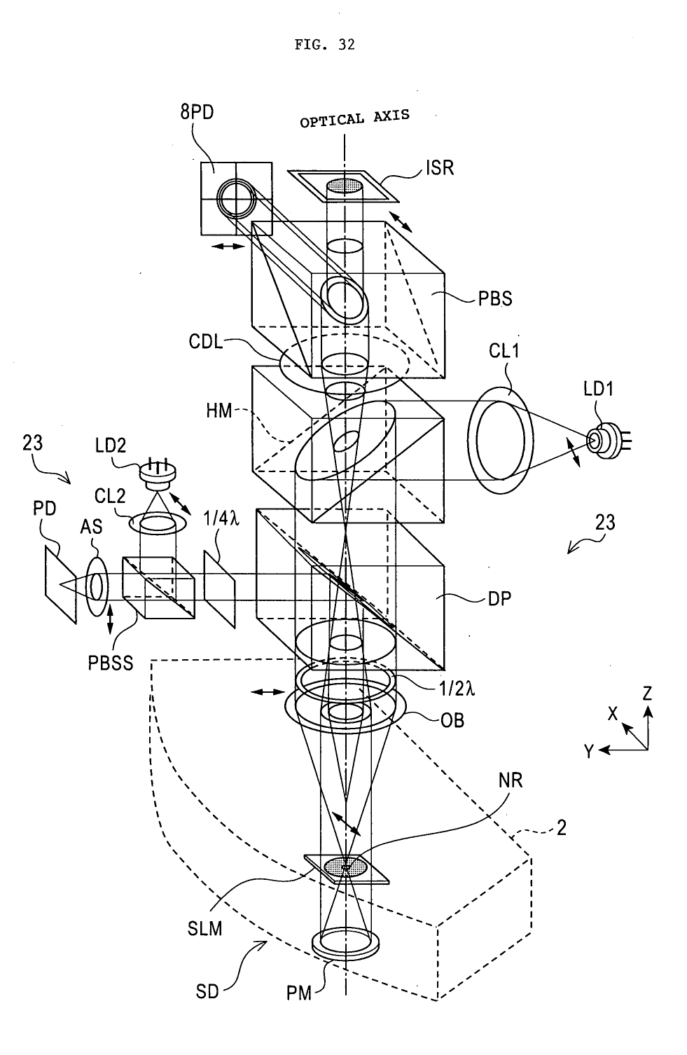

A description will now be given of a recording/reproducing method for recording or reproducing information by irradiating the disk 2 with light beams, using a hologram apparatus shown in FIG. 32.

At step 1, the servo laser LD2 is initially turned-on, and the disk 2 and the objective lens OB are adjusted in relative position (focus and tracking). At this point in time, the recording/reproducing laser LD1 is kept off or turned on at low power such that no hologram can be recorded. The objective lens driving unit performs a focus servo on the laser spot, thereby controlling the position of the objective lens OB with respect to the principle surface of the disk 2 (the distance between the objective lens OB and the disk 2) in the vertical direction (z-direction).

Next, at step 2, the recording/reproducing laser LD1 is turned on at low power (or kept on if it is already on), and the spatial light modulator SLM is set to a full transmission pattern, thereby forming an image of the annular spot on the reflection servo photodetector 8PD. The parabolic mirror PM is then moved for position control (the distance between the objective lens OB and the parabolic mirror PM) so that this image comes to a proper position. Here, the parabolic mirror PM and the spatial light modulator SLM are driven and adjusted integrally. Since the recording/reproducing laser LD1 is set to a low output, no hologram will be recorded at this step. By these adjustments, the objective lens OB, the disk 2, and the parabolic mirror PM are adjusted and positioned to predetermined positions.

At step 3, a recording data pattern is displayed on the spatial light modulator SLM, and the output of the recording/reproducing laser LD1 is increased to record a hologram on the recording layer of the disk 2. Here, the signal light past the disk 2 forms an image on the image sensor ISR through the objective lens OB and the condenser lens CDL. The image of the pattern on the spatial light modulator SLM and the reproduced image of the hologram just recorded form a mixed image on the image sensor ISR.

At step 4, the recording/reproducing laser LD1 is turned off (or switched to low output) when the recording ends. The disk 2 (or pickup) is moved relatively by its driving mechanism so that the optical axis generally falls on the position of the next servo mark. The disk 2 may be moved to an approximate position since strict positioning is preformed by the servo mechanism using the servo beam.

These steps 1 to 4 are repeated to record holograms on the disk 2 in succession.

Next, the flow of reproduction will be described.

At step 11, the servo laser LD2 shown in FIG. 32 is initially turned on, and the disk and the objective lens OB are adjusted in relative position (focus and tracking). At this point in time, the recording/reproducing laser is kept off or turned on at low power such that no hologram can be recorded.

At step 12, the recording/reproducing laser LD1 is turned on at low output (output for reproduction) with a full block pattern on the spatial light modulator SLM. The disk 2 is shielded from light coming from the backside, and is irradiated with the reference light alone. The reproduction light of a hologram emerges from the surface of the disk 2 toward the objective lens OB. Here, the reproduction light resulting from the reference light in the inner side of the ring-shaped half-wave plate ½λ forms an image on the image sensor ISR. The reproduction light resulting from the reference light passed through the ring-shaped half-wave plate ½λ forms an image on the reflection servo photodetector 8PD. Here, the image on the image sensor ISR alone is used. The image on the image sensor ISR is transmitted to the signal processing circuit to make a reproduction signal.

At step 13, the disk 2 is moved by the driving mechanism so that its optical axis generally falls on the position of the next servo mark. The disk 2 may be moved to an approximate position since strict positioning is preformed by the servo mechanism using the servo beam.

These steps 11 to 13 are repeated to reproduce holograms recorded on the disk 2 in succession. It should be noted that the recording/reproducing laser may be either on or off in steps 11 to 13.

While the foregoing embodiment has used the half-wave plate ½λ of ring shape, a half-wave plate may be formed as a ring pattern on a transparent plate. Moreover, a quarter-wave plate ¼λ may be similarly arranged in a ring shape instead of the half-wave plate ½λ. The same effect can also be obtained by using a peripheral beam ring of circular polarization, and splitting the servo beam component from the reproduction light with a polarizing beam splitter PBS.

### Embodiments of Spatial Light Modulator

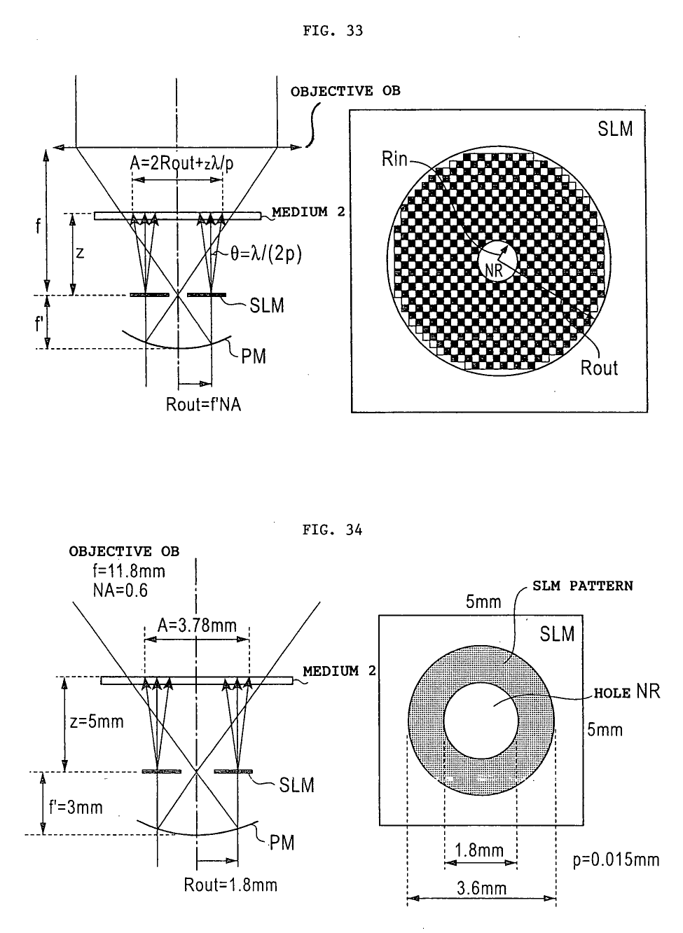

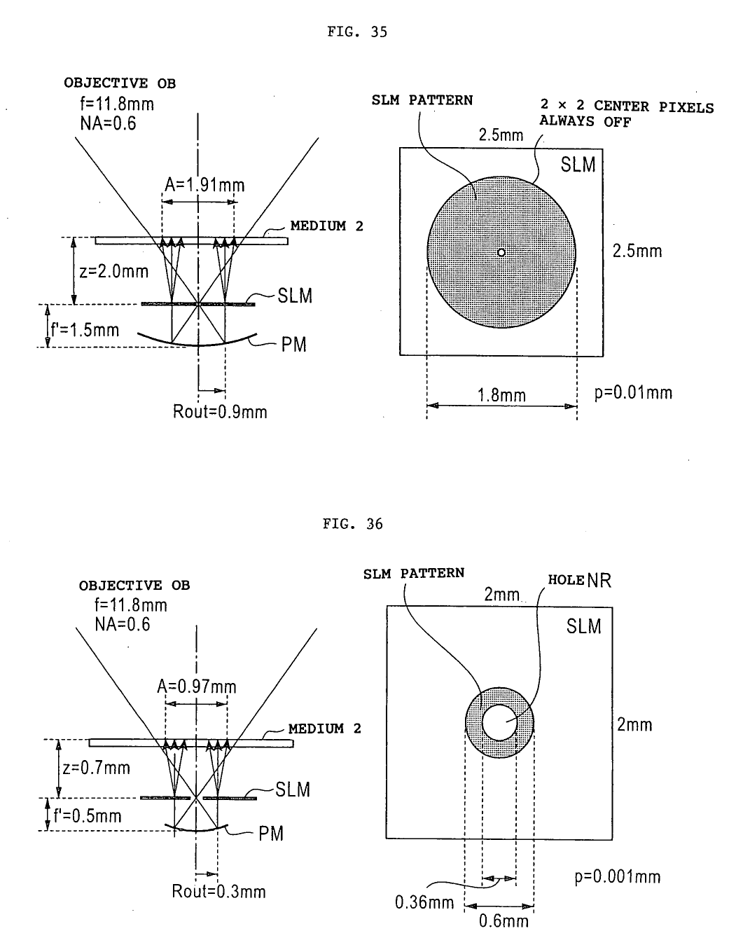

A description will now be given of specific shapes of the spatial light modulator SLM. In FIG. 33, an objective lens OB having a numerical aperture of NA is used to arrange the parabolic mirror PM at a distance of f′ from the spatial light modulator SLM. In this configuration, the parallel light reflected from the parabolic mirror PM has a beam radius Rout of:

Rₒᵤₜ=f′·NA

Then, the pattern of the spatial light modulator SLM has only to be arranged within a circle of radius Rout. The hole in the center has an arbitrary size of Rin, which can be reduced to increase the number of pixels. This, however, brings the crossing angle of the signal light and the reference light close to 180°, thereby lowering the angular selectivity and even deteriorating the degree of multiplexing. Rin can be increased to improve the degree of multiplexing, whereas the number of pixels decreases. An appropriate value may be selected depending on the situations.

The number of pixels is given by (the number of pixels)=(the sectional area of the signal light)/(the area of a single pixel). In a mathematical expression:

$$\frac{π ( {R}_{out}^{2} - {R}_{in}^{2} )}{{p}^{2}}$$

where p is the pixel pitch, assuming square pixels. In fact, pixels cannot be arranged on some of the outermost area and the innermost area as shown in the foregoing diagram, and the actual number of pixels is thus somewhat smaller than the value determined from the simple area ratios (the value of the foregoing equation).

The spatial light modulator SLM diffracts light with a maximum diffraction angle of θ=λ/2p. When the recording medium 2 is located at a distance z from the spatial light modulator SLM, the interference area therefore falls within a circle having a diameter of:

$$2 {R}_{out} + \frac{z λ}{p} .$$

### ARRANGEMENT EXAMPLE 1

A lens of NA=0.6 and f=11.8 mm is used as the objective lens OB. The parabolic mirror PM is placed at the position of f′=3 mm. Here, Rout=1.8 mm. As shown in the drawing, the spatial light modulator SLM is shaped into a square of 5 mm×5 mm outside, having a pattern inside a circular of 3.6 mm in diameter. A hole having a diameter of 1.8 mm is formed in the center. The pixel pitch P is 0.015 mm, and the number of effective pixels is approximately 33000. The interference area has a diameter of A=3.78 mm, which records a circular hologram of 3.78 mm in diameter. The recording medium 2 is shifted in small distances for multiplex recording.

### ARRANGEMENT EXAMPLE 2

This example will deal with a spatial light modulator SLM having a smaller center hole. The objective in use is the same. With f′=1.5 mm and Rout=0.9 mm, the spatial light modulator SLM has a pattern inside a circle of 1.8 mm in diameter as shown in the drawing. Instead of the center hole, 2×2 pixels at the center are kept OFF (in a transmitting state) all the time. The pixel pitch is 0.01 mm, so that the center area is equivalent to having a square hole of 0.02 mm×0.02 mm. It should be appreciated that a small hole may physically be formed. The number of pixels is approximately 25000, and the interference area has a diameter of 1.91 mm.

### ARRANGEMENT EXAMPLE 3

In this method, f′ can be modified in value to change the hologram size arbitrarily. This example will deal with the case of recording a hologram smaller than in the foregoing examples.

The objective lens OB is the same as in the previous example, with f′=0.5 mm and Rout=0.3 mm. The spatial light modulator SLM has a pattern inside a circle of 0.6 mm in diameter as shown in the drawing. The hole inside has a diameter of 0.36 mm. This hole may be achieved by an OFF display on the spatial light modulator SLM as in the arrangement example 2. With a pixel pitch of p=0.001 mm, the number of pixels is approximately 180000, and the interference area has a diameter of A=0.97 mm.

1. A hologram apparatus comprising: a suspension unit for holding a recording medium in a freely mountable fashion, the recording medium storing an optical interference pattern inside as a diffraction grating; a reference light optical system for emitting reference light toward said recording medium; and a signal light optical system for emitting signal light toward said recording medium, being arranged on a side opposite from said reference light optical system coaxially across said recording medium, the diffraction grating being formed by opposed irradiation of said recording medium with said signal light and said reference light, the apparatus further comprising:
an objective lens for condensing said reference light with a first numerical aperture; and
a spatial light modulation device for generating signal light from said reference light past said recording medium and making it pass through said recording medium with a second numerical aperture different from said first numerical aperture, said signal light being modulated according to recorded information.

2. The hologram apparatus according to claim 1, wherein said spatial light modulation device of said signal light optical system includes: a transmission type spatial light modulator arranged coaxially with said objective lens; a light transmission part formed in said spatial light modulator; and a reflecting part for reflecting light past said spatial light modulator.

3. The hologram apparatus according to claim 2, wherein: said objective lens condenses the reference light toward said light transmission part; and said spatial light modulator modulates said reference light reflected by said reflecting part, thereby generating said signal light.

4. The hologram apparatus according to claim 3, wherein said second numerical aperture is smaller than said first numerical aperture.

5. The hologram apparatus according to claim 4, wherein said second numerical aperture is zero.

6. The hologram apparatus according to claim 2, wherein: said objective lens projects the reference light to said spatial light modulator as generally parallel light; said spatial light modulator modulates the reference light into said signal light; and said signal light reflected by said reflecting part is condensed toward said light transmission part, thereby emitting said signal light of spherical wave.

7. The hologram apparatus according to claim 6, wherein said first numerical aperture is smaller than said second numerical aperture.

8. The hologram apparatus according to claim 7, wherein said first numerical aperture is zero.

9. The hologram apparatus according to claim 2, wherein said reflecting part includes a concave mirror which is arranged on said optical axis at a side of said spatial light modulator opposite from said recording medium and makes said reference light past said light transmission part pass through said spatial light modulator with said second numerical aperture.

10. The hologram apparatus according to claim 9, wherein said concave mirror is a parabolic mirror.

11. The hologram apparatus according to claim 2, wherein said reflecting part includes an assembly of a flat mirror and an optical device arranged coaxially in parallel, the assembly being arranged on said optical axis at a side of said spatial light modulator opposite from said recording medium and making said reference light past said light transmission part pass through said spatial light modulator with said second numerical aperture, said optical device having a convex lens function.

12. The hologram apparatus according to claim 11, wherein said optical device having a convex lens function is a convex lens.

13. The hologram apparatus according to claim 11, wherein said optical device having a convex lens function is a diffractive optical device having a convex lens function.

14. The hologram apparatus according to claim 11, wherein said optical device having a convex lens function is a planoconvex lens, having said flat mirror formed on a flat area thereof.

15. The hologram apparatus according to claim 2, wherein said reflecting part includes an assembly of a diffractive optical device having a convex lens function and a flat mirror arranged apart in parallel, the diffractive optical device being integrally formed on said spatial light modulator.

16. The hologram apparatus according to claim 2, wherein said light transmission part is a through opening or is made of a transparent material for transmitting the reference light.

17. The hologram apparatus according to claim 2, wherein said light transmission part is a part of said spatial light modulator in a light transmission state during recording.

18. The hologram apparatus according to claim 2, comprising: non-reflection means for stopping operation of said reflecting part so as not to reflect said reference light; a photodetector for detecting reproduction light generated from said recording medium by irradiation of the reference light, being arranged in said reference light optical system; and optical means for introducing said reproduction light from said objective lens to said photodetector.

19. A hologram recording method for a hologram apparatus including: a reference light optical system for emitting reference light to a recording medium by using an objective lens, the recording medium storing an optical interference pattern inside as a diffraction grating; and a signal light optical system for emitting signal light toward said recording medium, being arranged on a side opposite from said reference light optical system coaxially across said recording medium, the diffraction grating being formed by opposed irradiation of said recording medium with said signal light and said reference light, the method comprising the steps of:
condensing said reference light to said recording medium for transmission with a first numerical aperture, by using the objective lens in said reference light optical system;
passing said transmitted reference light through a spatial light modulator without modulation in said signal light optical system; and
reflecting said passed reference light by a reflecting part so that it is transmitted through said spatial light modulator, thereby generating said signal light modulated according to recorded information and passing it through the recording medium with a second numerical aperture different from the first numerical aperture.

20. The hologram recording method according to claim 19, wherein: said spatial light modulator has a light transmission part; said objective lens condenses the reference light toward said light transmission part; and said spatial light modulator modulates said reference light reflected by said reflecting part, thereby generating said signal light.

21. The hologram recording method according to claim 20, wherein said second numerical aperture is smaller than said first numerical aperture.

22. The hologram recording method according to claim 21, wherein said second numerical aperture is zero.

23. The hologram recording method according to claim 19, wherein: said spatial light modulator has a light transmission part; said objective lens projects the reference light to said spatial light modulator as generally parallel light; said spatial light modulator modulates the reference light into said signal light; and said signal light reflected by said reflecting part is condensed toward said light transmission part, thereby emitting said signal light of spherical wave.

24. The hologram recording method according to claim 23, wherein said first numerical aperture is smaller than said second numerical aperture.

25. The hologram recording method according to claim 24, wherein said first numerical aperture is zero.
